(19) United States
(12) Patent Application Publication
(10) Pub. No.: US 2024/0367054 A1
(43) Pub. Date: Nov. 7, 2024

(54) ARTIFICIAL INTELLIGENCE ELECTRONIC GAMING MACHINE PERSONALITIES

(71) Applicant: IGT, Las Vegas, NV (US)

(72) Inventors: Dwayne Nelson, Las Vegas, NV (US); Kevin Higgins, Reno, NV (US); Patrick Danielson, Las Vegas, NV (US)

(21) Appl. No.: 18/142,937

(22) Filed: May 3, 2023

(51) Int. Cl. A63F 13/67

(52) U.S. Cl. CPC A63F 13/67

(57) ABSTRACT

The present disclosure relates generally to a gaming system, device, and method supportive of a self-evolving, AI-based conversation model. The conversation model uses the state of the gaming system in autogenerating natural language messages. The state of the gaming system, for example, can be used in topic and sentiment classifications.

### BACKGROUND

The present disclosure is generally directed towards gaming devices and systems and, more specifically, self-evolving, artificial intelligence (AI)-based natural language processing.

Casino models have employed AI to analyze casino floor performance, propose to operators where and how many EGMs to place in their venue, and provide other casino floor performance recommendations.

### BRIEF SUMMARY

In certain aspects, the present disclosure relates to a gaming system, device, and method supportive of self-evolving, AI-based player and gaming system behaviors.

In an aspect, a system includes a communication interface, a processor coupled with the communication interface, and a computer-readable storage medium coupled with the processor. The computer readable storage medium stores a conversation model thereon that enables the processor to:
receive a natural language communication from a player's communication device in a communication session with a gaming system;
analyze the received natural language communication to determine a topic classification and a corresponding topic confidence score, the topic confidence score being based, at least in part, on information associated with a state of the gaming system;
select, based on the topic confidence score, a natural language response; and
transmit the selected natural language response to the player's communication device.

In an aspect, a method includes the steps of:
assigning a conversation model to interact with a player in a communication session with a communication device of the player, the conversation model being associated with a gaming system;
receiving a natural language communication from the player's communication device in the communication session;
based at least in part on information associated with a state of the gaming system and natural language processing of the received natural language communication, selecting, by the conversation model, a natural language response to the received natural language response;
transmitting the selected natural language response to the player's communication device;
identifying an actual behavior of the player in response to the selected natural language response; and
updating the assigned conversation model based on a difference between the actual behavior and a target behavior of the player associated with the selected natural language response.

In an aspect, a system includes a communication interface, a processor coupled with the communication interface, and a computer-readable storage medium coupled with the processor. The computer-readable storage medium comprises data that enables the processor to:
receive a natural language communication from a player of a gaming device during a gaming session;
extract, by natural language processing, one or more keywords from the received natural language communication to identify an intent of the natural language communication;
receive information associated with a state of the gaming session;
determine a sentiment classification and a corresponding sentiment confidence score for the received natural language communication, the sentiment confidence score being based, at least in part, on the received information;
select, based on the sentiment confidence score, a natural language response; and
transmit the selected natural language response to the player's communication device.

Additional features and advantages are described herein and will be apparent from the following Description and the figures.

### BRIEF DESCRIPTION OF THE SEVERAL VIEWS OF THE DRAWINGS

FIG. 1 is a block diagram of a gaming system in accordance with aspects of the present disclosure;

FIG. 2A is a block diagram illustrating a first example data structure used in accordance with aspects of the present disclosure;

FIG. 2B is a block diagram illustrating a second example data structure used in accordance with aspects of the present disclosure;

FIG. 2C is a block diagram illustrating a third example data structure used in accordance with aspects of the present disclosure;

FIG. 2D is a block diagram illustrating a third example data structure used in accordance with aspects of the present disclosure;

FIG. 3 is a block diagram of a gaming device in accordance with aspects of the present disclosure;

FIG. 4 is a block diagram illustrating self-evolving AI-based models in accordance with aspects of the present disclosure;

FIG. 5 is a screen shot of a player communication device in accordance with aspects of the present disclosure;

FIG. 6 is a screen shot of a player communication device in accordance with aspects of the present disclosure;

FIG. 7 is a screen shot of a player communication device in accordance with aspects of the present disclosure;

FIG. 8 is a screen shot of a player communication device in accordance with aspects of the present disclosure;

FIG. 9 is a process flow illustrating aspects of self-evolving, AI-based conversation model in accordance with aspects of the present disclosure; and

FIG. 10 is a process flow illustrating aspects of self-evolving, AI-based representative conversation model in accordance with aspects of the present disclosure.

### DETAILED DESCRIPTION

Aspects of the present disclosure will be described in connection with self-evolving, artificial intelligence (AI)-based conversation models (also referred to as self-learning, AI-based conversation models such as a chatbot) in an environment such as, for example, a casino environment. While some examples in the present disclosure may reference the use of an Electronic Gaming Machine (EGM) as a gaming device via which players may participate in gaming activity, it should be appreciated that aspects of the present disclosure are not so limited. For example, any computing device, personal gaming device, or collection of computing devices may be used to facilitate invoking and implementing self-evolving AI-based conversation models.

Although a gaming server of the gaming system typically hosts the AI-based conversation models or chatbots, the gaming system can use a virtual EGM, game or application on the EGM, EGM game theme, or other component of the gaming system (gaming system component) to create the impression that players receive texts or other messages from that component of the gaming system. For example, the gaming system component can be identified as “EGM Asset #123456” or “Luck Larry Game at Bellagio” or “Your favorite EGM”. The player can respond and communicate (e.g., chat) with the EGM. The gaming system can use a rule-based or AI or machine learning (ML) model that responds like a person, especially when each EGM has a unique personality catered to the player. While the AI conversation model can be executed completely on an EGM, it is typically hosted on the gaming system. Using a gaming system as a host can allow the conversation model to work across different gaming device manufacturers and even across product types. For example, the gaming system can facilitate messages between players and a stadium at the casino.

The gaming system can increase player engagement by allowing a player to engage with a virtual counterpart of the gaming system component even after they leave the casino premises. By way of illustration, the player believes that he/she is communicating directly with a gaming system component even though the player is actually communicating with a hosted communication session on the gaming server 116. For instance, when a first player texts a first gaming system component, the texts go to the conversation model on the gaming server 116 and the conversation model responds as if it were the first gaming system component and when the first gaming system component texts the first player, the texts come from the conversation model on the gaming server 116. The conversation model can act as a chat host that typically communicates with a messaging service, such as Twilio™, that sends and receives texts from the gaming server via wireless communication channels. The conversation model learns the configuration and gameplay information about the gaming system components, such as the games installed and player activity, and uses the learned configuration and gameplay information to send to the player more appropriate or valid autogenerated natural language messages. The conversation model communicates with other gaming components to learn about player session gameplay data.

Typical information or topics included by a conversation model in an autogenerated natural language message can include one or more of the following: the name of the property where the gaming system component is located, the relative location of the gaming system component on the casino floor (e.g., “by the bar”), an identifier of the gaming system component (e.g., “asset number 123445”), an activity level of the floor or one or more gaming system components, and recent game events at the gaming system of gaming system component level, such as jackpots and other awards (e.g., bonuses, free spins, etc.) on the same or different gaming system component, etc.

Typical topics of the player message processed by the conversation model includes one or more of the following: current jackpots (e.g., “What is the current jackpot amount?”), current gaming system or device configuration (e.g., “Can I wager $25.00?”), recent gaming system or device events (e.g., “When was the last jackpot?”, “When was the last bonus?”, and “What was the largest win today?”), player activity (e.g., “How many have played today?”), information about the gaming system or casino related events (e.g., (“What time is the concert tonight?”), and information about player activities that are scheduled (e.g., “Is my table ready at the steakhouse?”).

As described below, aspects of the present disclosure may use one or more self-evolving, AI-based conversation models to generate natural language communications and respond intelligently to such natural language communications received from players of gaming devices. The natural language communications can be text-based, voice-based, body movement-based, and combinations thereof and in accordance with any communications protocol or modality. For example, the natural language communications can be texts (e.g., short message service texts), emails, chats, static and video images in Instagram or other social network postings, Apple Messages™, Facebook™messenger, What's App™, or other custom application enabling messaging. and the like. The conversation model can enable the player to have a social experience with a virtual gaming system component representing an actual gaming system component or other gaming system component not only in the casino but also from anywhere in the world.

The natural language communications can take the form of a conversation. As used herein, a conversation may correspond to an interaction or exchange of observations, opinions, questions, responses to questions, or ideas. A conversation topic may correspond to a particular subject or set of subjects that are discussed between two or more entities involved in a communication session (regardless of whether the session is synchronous or asynchronous). Interactions, as used herein, may correspond to two or more message exchanges between two or more entities over a digital communication channel. As used herein, a message may include one or multiple electronic records, text, rich media, or data structures that are transmitted from one communication device to another communication device via a communication network. A message may be transmitted via one or more data packets and the formatting of such data packets may depend upon the messaging protocol used for transmitting the electronic records over the communication network. In some embodiments, an interaction may correspond to a question and response message pair, a question and question message pair, a statement and response message pair, or a set of messages.

While the present disclosure is described in terms of texting, it is to be understood that it can also apply to voice input, such as voice commands. For example, the player could talk with the conversation model directly or via a mobile device instead of typing and receiving text commands. In that event, a speech-to-text conversion would translate the player's voice input into a text equivalent for processing by the conversation model and a text-to-speech conversion would translate an autogenerated natural language message from the conversation model into a voice equivalent for transmission or presentation to the player's communication device.

The natural language communication in a conversation may relate to one or more topics (or topic classifications) related to the gaming system or an operation or configuration thereof. As used herein, a topic classification may correspond to an identification of a conversation topic. The topic classification may include a classification number (e.g., where a particular number corresponds to a particular pre-defined topic). The topic classification may alternatively or additionally include a user-defined topic, a machine-defined topic, or some other description of a topic using a finite set of symbols or characters. A conversation may encompass one or multiple topics and, therefore, may be assigned one or many topic classifications, as appropriate. Exemplary topic classifications relate to one or more of a location associated with the gaming system, an identifier associated with the gaming system, a state of the gaming system, an activity level of the gaming system, and an event associated with the gaming system. A state of the gaming system refers to a state of one or more gaming devices in the gaming system and/or the state of the gaming system as a whole. The state of the gaming system is typically indicated by gameplay and configuration data collected from one or more gaming devices and/or the gaming system as a whole, predicted gameplay and configuration data and player activity or non-activity in or associated with the gaming system.

The conversation model can base natural language messages on a number of factors including a state of the gaming system, a state of the communication session, and/or current and/or historic player behavior data. The conversation model can be updated based on a validity of the generated natural language communication. The validity can be based on a number of factors, including for example player input on the appropriateness of the generated natural language communication, an actual behavior of the player identified as being in response to the generated natural language communication, and a difference between a target player behavior associated with the generated natural language communication and the actual behavior of the player in response thereto. The target behavior can be selected based on a variety of criteria, including the physical location and a state of a gaming device in the gaming system. The target and actual behaviors can relate, for example, to one or more of content of a further communication received from the player and an action of the player performed within a defined time interval of message transmission or receipt.

The state of the gaming system can be based on observed real-time gameplay data of the player during a concurrent gaming session (considering factors such as game outcome, game theme, speed of play, cash in amount, cash out amount, play session length, additional in-session cash in amounts, wager behavior (e.g., change of wager behavior, average wager amount, Min/Max wager amount, wager to win correlation, number of lines played, denomination selected, side bet features activated/deactivated, and playing double-up or similar features and other metrics of wager behavior), wagering speed, idle time, etc. The conversation model can, for instance, respond to the player text or other messages dependent upon the conversation model selected and state of the conversation. In addition, the conversation model can include messages to discuss the state of the game or gaming system component, gaming device, or casino floor, such as a current jackpot amount, recent hit, overdue jackpot, new game, new feature, casino floor activity level, etc.

The conversation model can be a natural language processing model that corresponds to a machine learning model, such as a data set that is useable in a neural network and that has been trained by one or more data sets that describe conversations or message exchanges between two or more entities. The conversation model may be stored as a model data file or any other data structure that is usable within a neural network or an AI system. In addition to a data set that describes conversations or message exchanges between two or more entities, the model may be trained using the gameplay data, player information, and other gaming system state information, such as slot machine configurations and operations, payment methods, money transfer methods, game mechanics, and other gameplay and gaming system information.

In one embodiment, the gaming system has a single conversation model for all players while in other embodiments a unique conversation model is maintained for each player. One or more conversation models can be concurrently assigned to one or more communication sessions. The conversational model(s) can receive gameplay data of multiple gaming sessions of multiple different players on different gaming devices and/or configuration data associated with each of the gaming devices. Each of the communication sessions can share a common host communication address associated with the gaming system. The state of the gaming system used in each communication session can be based on the collective gameplay and configuration data for multiple gaming sessions or the gameplay and configuration data associated only with the particular gaming session.

A different conversational model can interact with each communication device in each of the communication sessions. The conversational model can be based on a loyalty account status, a set of player preferences, a player social media data, and/or gameplay of the player.

The gaming system can transmit an initial natural language communication to the communication device of the player to start a conversation or communication session. The initial natural language communication can be sent, for example, in response to a passage of time, a gaming event in a gaming session of the player, an event of the gaming system, and/or a level of player engagement with the gaming system.

In response to the player interacting with a gaming device of the gaming system, the gaming system can transfer the communication session from a communication device of the player to the gaming device by substituting an endpoint communication address of the player's communication device with a communication address of the gaming device to enable the gaming device, via an application or service window, to send and receive player communications during the communication session.

To avoid communicating potentially sensitive information with an unauthorized person, the gaming system can authenticate that the communication device is associated with the player before transmitting the natural language communication. This can be done by any suitable authentication techniques, such as single use passwords or passcodes, digital certificate, image recognition by gaming system camera still or video images, and other knowledge-based, physiological biometrics-based, behavioral biometrics-based, and two/multi-factor authentication techniques. This transfer could occur based upon the player inserting their player's club card into the EGM/Slot Machine Interface Board (SMIB), or validating their player's club card PIN at the EGM/SMIB, etc. In addition, the conversation model can be restricted from providing sensitive information to the player in any generated natural language message. This can be done by including sensitivity tags or other metadata in sensitive fields of the player's profile.

The AI-enabled conversation models can make a real-time determination of which possible message has the highest likelihood of producing a desired or target player behavior by using not only on general information relating to the gaming system state but also on real-time and historic gameplay data of one or more players, including the player in question. AI can observe and compare in real time one or more players' behaviors and the respective revenues realized by the players as a function of time-which cannot be done mentally.

The conversation model can be fully executed by the AI system without the involvement of casino or gaming staff to assist in message formulation. The AI system can enable the gaming system to use auto-generated natural language communications not only to communicate with the player to produce desired or target behaviors but also to control gaming device functions, operations, and configurations at the request of the player.

The conversation model can induce an illusion of gaming system familiarity and awareness of the player's needs, desires, and activities, which can enhance player satisfaction and enable gaming systems operators to have higher levels of floor (e.g., casino gaming device) utilization by selecting EGMs in less occupied areas of the floor as the gaming participant in a conversation or interaction with a player. Furthermore, the AI component can enable the gaming system to operate much faster and much more accurately with more appropriate messaging for players compared to traditional gaming system messaging systems.

In some gaming environments (e.g., casino environments), an EGM may include a conventional intelligent agent (e.g., a gameplay assistant, a gameplay model, a player companion, etc.) which, when activated during a gameplay session at the EGM, may assist the player and/or server as a personalization enabler. However, in some other implementations of conventional intelligent agents, the player behaviors are hard-coded and created with either common player traits (e.g., generic behaviors, personalities, etc.) and/or are based upon a relatively limited number of parameters. A technical problem of such conventional intelligent agents is their inability to behave “intelligently” (e.g., in more complex gameplay situations) in supporting user-tailored experiences. For example, in some systems, such intelligent agents are not fed with additional data (e.g., feedback, gameplay data, etc.) and are unable to evolve beyond a base model. In some cases, the conventional intelligent agents are incapable of drawing on self-learning implications.

A further technical problem of conventional intelligent agents is how to create, update, maintain and use output from gaming system operations in self-evolving AI-based models to enhance performance of a gaming system. Data processing to maintain these models, in real-time across many players at one-second intervals, is computationally challenging and intensive. How to incorporate such models into existing gaming systems to enhance gaming system operation and player enjoyment without undue computational costs and processing latency creates yet another technical problem.

A technical solution provided by aspects of the present disclosure inputs gaming system operational information into natural language conversation models in a casino environment (e.g., associated with EGMs) in which the models are capable of self-evolving (also referred to herein as self-learning) based on gameplay events, gameplay operations, gameplay decisions, gameplay outcomes, and other player related or gaming system-related parameters (e.g., behavioral shifts in gameplay decisions, biometric data, wager behavior, etc.) to provide more appropriate conversations and interactions with players. For example, a gameplay system may support initial training and creation of a baseline conversation model, in which the baseline conversation model is associated with a corresponding object (e.g., individual player, representative player, gaming system, or gaming device). The system may continuously feed the model with real time player and gaming system data (e.g., gameplay decisions, behavioral shifts, button inputs, etc.) generated by the player or EGM or other gaming system component in association with a gameplay session. In some aspects, via AI mechanisms, the model may self-evolve to enhance itself on order to optimize the messaging interaction between the gaming system and the player. In addition to the models ability to use real-time gameplay data to maintain/update/improve model capabilities, the models can provide output to the operator that can be used internally (for in-depth analysis purposes). Aspects of the present disclosure describe example techniques associated with generating such models, example methods of implementing the models in a gameplay environment (e.g., casino environment), examples of modifying the models, and example use-cases thereof.

For example, aspects of the present disclosure support the creation and application of “intelligent,” self-learning conversation models. In an example, the models described herein may support learning or evolving based on multiple different input sources (e.g., player data, player-related parameters (e.g., speed of play, cash in amount, cash out amount, play session length, additional in-session cash in amounts, wager behavior, wagering speed, and idle time), etc.) to increase the complexity and range of functionality of the models. Accordingly, for example, the conversation model can select a natural language message, from a plurality of natural language messages, to induce a player to behave in a targeted manner or produce a target behavior. The accuracy of the prediction can be used to update or modify the conversation model to yield more accurate predictive performance in future player interactions.

Example aspects of the present disclosure may provide increased gaming experience for players (e.g., utilizing conversation models) by providing more variety and higher levels of player excitement. In some examples, employment of conversation models may provide increased player engagement created via utilized player-based gaming, which may support higher revenue (e.g., at a casino venue).

According to example aspects of the present disclosure, a gaming server (and/or a gaming device) may track, in real time for multiple players and as input into the conversation model, player gameplay data in different gameplay sessions and all game situations (e.g., gameplay decisions with respect to decision events such as gameplay choices, slot pulls, bonus selections, etc.) to generate real time gameplay data (or gameplay data such as average speed of play, average cash in amount, average cash out amount, average play session length, average additional in-session cash in amounts, average wager behavior, average wagering speed, and average idle time for historical gameplay sessions).

For example, the gaming server may log the gameplay data and provide (e.g., using a machine learning engine, also referred to herein as a machine learning network) real-time natural language messaging in response to the logged gameplay data. In some aspects, using the machine learning engine, the gaming server may extract meaningful patterns from conversations and interactions and gameplay data and use the extracted meaningful patterns to make decisions and/or predictions that are based on a data that is relatively larger and higher in complexity compared to data analysis in some other systems. For example, aspects of the present disclosure support machine learning decisions and predictions that provide analysis beyond “simple” mathematical calculations implemented in some techniques which focus only on pure data analysis. The machine learning network can create a model with tunable parameters that can adjust themselves to messaging in conversational interactions with players and available gameplay data followed by receiving new messaging and gameplay data and enabling the model to extrapolate. The conversation model can thus balance between precisely capturing known data, such as producing the target behavior as the player's actual behavior, while generalizing enough to predict the behavior of unknown data.

Based on the gameplay data, the machine learning network can modify a conversation model corresponding to each of the players, the corresponding conversation model of each player being different from one another, or a collective conversation model representing a collective set of players. In some aspects, summarized and/or granular gameplay data can be used to create, maintain, and update the self-evolving, AI-based conversation models. In some embodiments, the machine learning network can modify a conversation model based on output from a self-evolving, AI-based gaming system behavior model. Using summarized and granular gameplay data in various proportions as inputs to conversation models can provide substantial computational savings and increase computational efficiencies. This can enable the real time application of the conversation model as gameplay data is received, thereby limiting program latency due to data processing limitations.

Aspects of the present disclosure may provide explicit improvements through AI. For example, systems described herein may support more accurate recommendations (e.g., message recommendations by the conversation model) and/or predictions of behaviors (e.g., target player behaviors) based on a huge number of historical player behavior data. In some aspects, multiple thousands (e.g., millions) of historical events may be incorporated into a conversation model(s) described herein. Aspects of the present disclosure support modifying (e.g., changing, adjusting) the model(s) over time, based on single events (e.g., per each instance of a gameplay event such as granular gameplay data), groups of events (e.g., per multiple instances of gameplay events such as summarized gameplay data). Example techniques described herein may provide reduced processing overhead (e.g., computing power, calculation time, etc.) compared to other techniques that analyze all single entries of historical data and compare the entries against new data, instead of using an AI model.

Aspects of the present disclosure may support output-learnings. For example, the gaming server (e.g., using a machine learning network and a model, etc.) may compare an action or event (e.g., a new natural language message, etc.) to previous actions and/or events (e.g., a prior natural language message by the same or a different player) (also referred to herein as historical actions and/or historical events) by a player. In an example, the gaming server may determine that there is a match between the action or event and a previous action or event. For example, the gaming server may determine that the action or event is the same as a previous action or event (or similar to the previous action or event with respect to a deviation threshold) under similar gameplay conditions. This comparison could be rigid, or another factor could be introduced in order to induce some randomness into the behavior.

In some aspects, the gaming server may determine that there is a match between an actual action or event (e.g., a natural language message received from a player, gameplay decision, entry, outcome, or other gameplay parameter) and a target action or event (e.g., a natural language message, a gameplay decision, entry, outcome, or other gameplay parameter) predicted by the gaming server in connection with a previously transmitted natural language message. The gaming server may add the action or event to a history of previous gameplay actions or events (also referred to herein as historical recordings) so as to establish and/or verify accuracy or validity of an applied model with respect to the action or event. The history may be implemented at a database, a memory, or the like.

Additionally, or alternatively, the gaming server may determine that there is not a match between the action or event and a previous action or event. For example, the gaming server may determine the action or event is different from a previous action or event under similar gameplay conditions, the action or event exceeds a similarity or deviation threshold with respect to the previous action or event, the action or event is different from and/or exceeds the similarity or deviation threshold with respect to an action or event predicted by the gaming server, etc. The gaming server (e.g., using a machine learning engine) may apply learning techniques associated with identifying the reason of the mismatch. For example, the gaming server may identify whether the mismatch is a result of a spontaneous or non-rational decision by the player, a general behavioral shift of the player, gameplay or configuration parameter change, change in player environment, an external factor (e.g., time of day, day of week, or holiday), etc.

In some aspects, the gaming server may identify behavioral changes (e.g., potential new behaviors, behavioral shifts, etc.) associated with the player, group of players, or gaming system, and the gaming server may modify tunable model parameters of the appropriate conversation model based on the behavioral changes. That is, for example, the gaming server may modify the model to account for different behavioral changes when providing recommended actions or target behavior predictions.

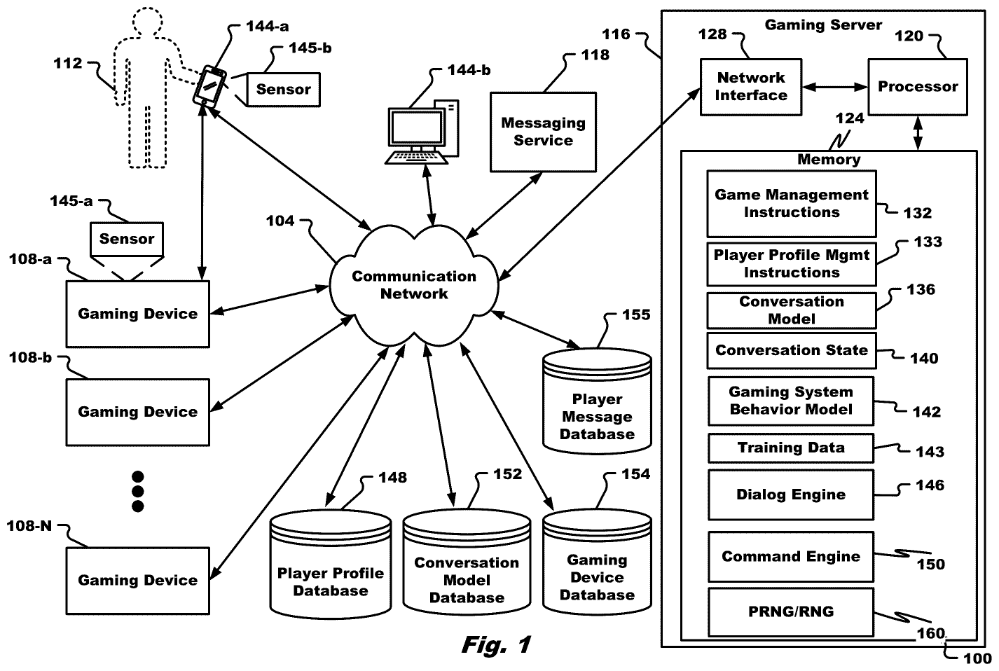

With reference initially to FIG. 1, details of an illustrative gaming system 100 will be described in accordance with at least some embodiments of the present disclosure. The components of the gaming system 100, while depicted as having particular instruction sets and devices, are not necessarily limited to the examples depicted herein. Rather, a system according to embodiments of the present disclosure may include one, some, or all of the components depicted in the gaming system 100 and does not necessarily have to include all of the components in a single device. For example, the components of a server may be distributed amongst a plurality of servers and/or other devices (e.g., a gaming device, a portable user device, etc.) in the gaming system 100 without departing from the scope of the present disclosure.

The gaming system 100 may include a communication network 104 that interconnects and facilitates machine-to-machine communications between one or multiple gaming devices 108 (e.g., any of gaming device 108-a through 108-N) and a gaming server 116. It should be appreciated that the communication network 104 may correspond to one or many communication networks without departing from the scope of the present disclosure. In some embodiments, gaming device 108-a through gaming device 108-N and gaming server(s) 116 may be configured to communicate using various nodes or components of the communication network 104. The communication network 104 may include any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may include a number of different communication media such as coaxial cable, copper cable/wire, fiber-optic cable, antennas for transmitting/receiving wireless messages, and combinations thereof.

A messaging service 118 can be in communication with the gaming system 100 via the communication network 104. The messaging service 118 can be any messaging provider to enable a user to send and receive messages. A messaging system manages the channels that define the paths of communication between endpoints and the sending and receiving of messages. Examples of instant messaging applications are short messaging service (SMS), Multimedia Messaging Service (MMS), email, WhatsApp Messenger™, Facebook Messenger™, Telegram™, Threeme™, Viber™, Website Messenger™, WeChat, KakaoTalk™, Kik™, Twilio™, Twitter™, iMessage™, and Line™. For purposes of this disclosure, communications enabled by social networking sites, such as Twitter™ and Facebook™, are considered to be conversations

In some embodiments, the gaming devices 108 (e.g., gaming device 108-a through gaming device 108-N) may be distributed throughout a single property or premises (e.g., a single casino floor), or the gaming devices 108 (e.g., gaming device 108-a through gaming device 108-N) may be distributed among a plurality of different properties. In a situation where the gaming devices 108 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming devices 108 (e.g., gaming device 108-a through gaming device 108-N) may utilize the same or different types of communication protocols to connect with the communication network 104. It should also be appreciated that the gaming devices 108 (e.g., gaming device 108-a through gaming device 108-N) may present the same type of game or different types of games to a player 112. For example, the gaming device 108-a may correspond to a gaming machine that presents a slot game to the player 112, the gaming device 108-b may correspond to a video poker machine, and other gaming devices 108 may present other types of games (e.g., keno, sports wagering, etc.) or a plurality of different games for selection and eventual play by the player 112.

In some aspects, some of the gaming devices 108 (e.g., gaming device 108-a through gaming device 108-N) may communicate or exchange data with one another via the communication network 104. In some embodiments, one or more of the gaming devices 108 may be configured to communicate directly with a centralized management server and/or the gaming server 116. Although not depicted, the gaming system 100 may include a separate server or collection of servers that are responsible for managing the operation of the various gaming devices 108 in the gaming system 100.

It should also be appreciated that the gaming server 116 may or may not be co-located with one or more gaming devices in the same property or premises. Thus, one or more gaming devices may communicate with the gaming server 116 over a WAN, such as the Internet. In such an event, a tunneling protocol or Virtual Private Network (VPN) may be established over a portion of the communication network 104 to ensure that communications between an EGM and the server 116 (e.g., a remotely-located server) are secured.

The gaming devices 108 (e.g., gaming device 108-a through gaming device 108-N) may correspond to a type of device that supports interaction by a player 112 in connection with playing games of chance. Examples of a gaming device 108 may include any type of known gaming device such as an EGM, a slot machine, a table game, an electronic table game (e.g., video poker), a skill-based game, etc. In addition to playing games on a gaming device 108, the player 112 may also be allowed to interact with and play games of chance on a communication device 144.

The gaming system 100 may support interaction with one or more communication devices 144. A communication device 144 (e.g., communication device 144-a) may be a mobile device of a player 112 (e.g., a personal communication device such as a smart phone, a tablet, a smart watch, etc.) or to a device issued by a casino to the player 112. It should be appreciated that the player 112 may play games directly on the communication device 144. Alternatively, or additionally, the communication device 144 may establish a communications (e.g., over a wireless or wired connection) with a gaming device 108 such that the communication device 144 provides an interface for the player 112 to interact with the gaming device 108. As shown in FIG. 1, the communication device 144 may be in communication with the communication network 104 or in direct communication (e.g., via Bluetooth, WiFi, etc.) with a gaming device 108. Non-limiting examples of a communication device 144 include a cellular phone, a smart phone, a tablet, a wearable device, an augmented reality headset, a virtual reality headset, a laptop, a Personal Computer (PC), or the like. In some cases, another communication device 144 (e.g., communication device 144-b) may be a mobile device, a PC, or the like of a casino operator (e.g., a floor attendant, a casino manager, etc.).

In some cases, the gaming system 100 may support “carding in” of a player at a gaming device 108 with a physical card (e.g., a player club card). In other cases, the gaming system 100 may support “carding in” of a player at a gaming device 108 via a mobile application on a communication device 144. In some aspects, the mobile application may support fund transfers between a player account and the gaming device 108 (e.g., a server, the casino). For example, using the mobile application, the player may transfer funds to a gameplay session.

In an example of “carding in,” the communication device 144 may exchange information with the gaming device 108 over a wireless connection (e.g., near field communication (NFC), Bluetooth, etc.) when the communication device 144 is within a threshold distance of the gaming device 108. In another aspect, the communication device 144 may “card in” and exchange information with the gaming device 108 when the communication device 144 is connected to the gaming device 108 using a physical communications link (e.g., a communications cable). In an example, when “carding in,” the communication device 144 may provide player identification information (e.g., player identity, player club status, player preference information, etc.) to the gaming device, the server, and/or the gaming system. The gaming server 116 (or the gaming device 108) may establish a gameplay session at the gaming device 108 for the player based on the information provided during the “card in.”

In an embodiment, the gaming system only enables auto-generated natural language messages in a conversation with a player after he or she successfully cards in to the gaming system. Stated differently, no auto-generated natural language messages are exchanged with the player before he or she successfully cards in or after he or she cards out. In this manner, natural language messages are not exchanged with an authorized person who happens to have the player's communication device 144.

The gaming server 116 is further shown to include a processor 120, a memory 124, and a network interface 128. These resources may enable functionality of the gaming server 116 as will be described herein. For example, the network interface 128 provides the server 116 with the ability to send and receive communication packets or the like over the communication network 104. The network interface 128 may be provided as a network interface card (NIC), a network port, drivers for the same, and the like. Communications between the components of the server 116 and other devices connected to the communication network 104 may all flow through the network interface 128.

The processor 120 may correspond to one or many computer processing devices. For example, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), or plurality of microprocessors that are configured to execute the instructions sets stored in memory 124. Upon executing the instruction sets stored in memory 124, the processor 120 enables various authentication functions of the gaming server 116.

The memory 124 may include any type of computer memory device or collection of computer memory devices. The memory 124 may be volatile or non-volatile in nature and, in some embodiments, may include a plurality of different memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. Although not depicted, the memory 124 may include instructions that enable the processor 120 to store data to and retrieve data from a player profile database 148, a conversation model database 152, a gaming device database 154, and/or a player message database 155.

Alternatively or additionally, the player profile database 148 or data stored thereon may be stored internal to the any of the communication device 144, a gaming device 108, and/or the server 116 (e.g., within the memory 124 of the server 116 rather than in a separate database). Alternatively or additionally, the conversation model database 152 or data stored therein may be stored internal to the server 116. Alternatively or additionally, the gaming device database 154 or data stored thereon may be stored internal to the server 116.

The databases described herein (e.g., player profile database 148, conversation model database 152, gaming device database 154) may include a relational database, a centralized database, a distributed database, an operational database, a hierarchical database, a network database, an object-oriented database, a graph database, a NoSQL (non-relational) database, etc. In some aspects, the databases may store and provide access to, for example, any of the stored data described herein.

In some aspects, the gaming system 100 may be implemented using a fully software-based solution. In some other aspects, the gaming system 100 may be implemented using a combination of software and hardware accelerators for offloading AI processing tasks and/or AI data handled at the gaming system 100. Aspects of the present disclosure and solutions thereof may be used locally at an EGM (e.g., a gaming device 108), a local server (e.g., gaming server 116 or a different server), and/or on a cloud server (e.g., gaming server 116 or a different server). Example processors (also referred to herein as co-processors) usable for offloading the AI processing tasks and/or AI data may include any combination of GPUs, ASICs, FPGAs, or the like. In some aspects, the processors (e.g., co-processors) may be located at a gaming device 108 and/or the gaming server 116. In some other aspects, processors (e.g., co-processors) located at a communication device 144 (e.g., a cellular phone, a smart phone, a tablet, a wearable device, an augmented reality headset, a virtual reality headset, etc.) may be used for offloading the AI processing tasks and/or AI data.

The gaming server 116 may support example aspects described herein of acquiring sensor data associated with a gameplay session using any combination of sensors 145 (e.g., sensor 145-a, sensor 145-b, etc.) (also referred to herein as sensor devices). The sensors 145 may be implemented at (e.g., integrated in) any combination of gaming devices 108 and/or communication devices 144. In some aspects, the sensors 145 may be standalone devices capable of communicating with any component (e.g., a gaming device 108, a gaming system 100, a database, etc.) of the gaming system 100, for example, via the communication network 104. In some aspects, the sensors 145 may provide the sensor data to a machine learning engine 141, aspects of which are described later herein.

In some aspects, the sensors 145 may include any combination of: an image sensor, an eye tracking sensor, a heart rate sensor, an infrared sensor, an audio sensor (e.g., a microphone), a pulse sensor, an oxygen sensor, a temperature sensor, a pressure sensor (e.g., integrated within a button, a keypad, etc.), a touch screen sensor, a vibration sensor, a motion sensor, an accelerometer, or the like. In some cases, the sensors 145 may be integrated within a physical interface of a gaming device 108 or a communication device 144. In some cases, the sensors 145 may be integrated at or within a threshold distance of a gaming device 108. For example, the sensors 145 may be integrated with a seat cushion, an arm rest, a seat back, a pull handle, a “spin” button, etc.

In some examples, the sensors 145 may capture or measure, as part of gameplay data, biometric data (e.g., facial features, facial response, eye movement, pupil dilation, heart rate, temperature, pulse, speech or speech patterns, breathing pattern, etc.) of a player with respect to a decision event, a gameplay decision, and/or a gameplay result in association with a gameplay session. The sensors 145 may detect changes and/or patterns in biometric data in association with a decision event, a gameplay decision, and/or a gameplay result in association with a gameplay session. In some aspects, the sensors 145 may include smart sensors capable of scanning and/or measuring a player's biometric parameters such as pulse, breathing rate, heart rate, eye focus, body movement, attention, electroencephalogram (EEG) parameters (e.g., electrical activity of the brain), electrocardiogram (ECG or EKG) parameters (e.g., heard rhythm and electrical activity), voice, speech pattern, etc.

In some other examples, the sensors 145 may capture or measure, as part of gameplay data, a value (e.g., force, velocity, etc.) corresponding to physical inputs (e.g., button presses, etc.) by the player at a gaming device 108 in association with a decision event, a gameplay decision, and/or a gameplay result in association with a gameplay session. For example, a sensor 145 (e.g., sensor 145-a) at a gaming device 108 (e.g., gaming device 108-a) may be a pressure sensor integrated within a button (e.g., a “spin” button, a “bet” button, etc.) at the gaming device 108, and the sensor 145 may capture or measure a value indicating a force at which the player presses the button.

In some other examples, the sensors 145 enable player tracking using a location-based tracking service in which an application or other software in the sensor uses global positioning service (GPS), radio frequency identifier (RFID), Wi-Fi or cellular data to trigger a pre-programmed action when a communication device 144 or RFID tag carried by the player enters or exits a virtual boundary set up around a geographical location. Entering or exiting the geographical location can prompt the conversation model to establish a conversation or messaging session with the player, such as by a mobile push notification, text message or alert, etc.

Aspects of the present disclosure support providing the sensor data (e.g., biometric data, value corresponding to a physical input, etc.) as part of the gameplay data to a conversation model. The conversation model may use the sensor data to predict emotional states or sentiment or tone classifications in connection with a game (e.g., game outcome, bonus game, jackpot, secondary bonus game, and other game event). Using the sensor data, for example, the conversation model may determine emotional or sentiment or tone thresholds (e.g., level of satisfaction, excitement, happiness, etc.) associated with the player and/or predict emotional states or sentiments or tones associated with the player that may be used in selecting and autogenerating a natural language message.

Aspects of the present disclosure support providing the sensor data (e.g., image or player location data) as part of the gameplay data to the conversation model. The conversation model may use the sensor data to predict player real-time location in the casino or gaming system. The conversation model may use the player location to select a gaming device 108 as a virtual message source and appropriate natural language message to transmit to the player to induce the player to visit the gaming device (e.g., the target behavior).

The illustrative instruction sets that may be stored in memory 124 include, without limitation, a game management instruction set 132, player profile management instructions 133, conversation model(s) 136, gaming system behavior model 142, and command engine 150. Functions of the server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 116. Said another way, the particular instruction sets depicted in FIG. 1 should not be construed as limiting embodiments described herein. Data that may be stored in memory includes conversation state 140 and training data 143.

The game management instruction set 132, when executed by the processor 120, may enable the gaming server 116 to manage the various games played by a player 112 at the gaming devices 108 (e.g., gaming device 108-a through gaming device 108-N) and/or a communication device 144 carried by the player 112. For example, any game played by the player 112 at any of the gaming devices 108 and/or communication device 144 may be managed, partially or entirely, by execution of the game management instruction set 132. The game management instruction set 132 may also be configured to track a status of wager events (e.g., non-EGM wager games, sporting events, bingo, keno, lottery, etc.) and whether a player 112 has placed a wager on such events. In some embodiments, when a wager event has come to completion such that wagers made on the event become payable (e.g., at the end of a gameplay decision at a gaming device 108 and/or communication device 144, at the end of a sporting event when the final score of the event is determined), the game management instruction set 132 may update states and/or values of tickets/vouchers issued for the event appropriately.

In some aspects, the game management instruction set 132, when executed by the processor 120, may enable the gaming server 116 to manage and/or monitor data associated with a gameplay session at a gaming device 108. For example, the gaming server 116 may support example aspects described herein of monitoring user information (e.g., member identification information, player club status, etc.), gameplay data (e.g., quantity of plays, quantity of spins, duration of gameplay, credits spent, credits earned, etc.), and other gameplay data described above. The gaming server 116 may update the gaming device database 154, obtain information from the gaming device database 154, and notify the game management instruction set 132, etc.

The player profile management instruction set 133, when executed by the processor 120, may enable the gaming server 116 to manage one or more player profiles within the player profile database 148. In some embodiments, the player profile management instruction set 133 may be configured to manage a player loyalty profile including settings for such player profiles, available wager credits for such profiles, determine player wager history, loyalty reward account balance, loyalty reward eligibility, and/or determine which, if any, tickets/vouchers are associated with a particular player. It should also be appreciated that the player profile management instruction set 133 may be configured to manage player profiles of players that do not have loyalty accounts or any other predetermined player account.

In some aspects, the player profile management instruction set 133 may be configured to manage a player activity, current and/or historical, associated with gameplay sessions. For example, the player activity may include granular data 400 based on each gameplay action tracked by a gaming device (e.g., spin level) during a gameplay session. The granular gameplay data, or attributes or instances or feature vectors, can be extracted from EGM/VLT logs and data and, for each gameplay session, include, for example: total cash in amount (the total amount of money inserted by the player in the machine during a play session), average primary wager, standard deviation of primary wager, number of distinct primary wagers, number of primary wagers, total (sum of) primary wagers, session length (elapsed time is the amount of time that passes from the start of a session to the end of the session), number of games played (number of different primary themes played in a session), number of times the bonus was experienced (number of secondary games played in a session), possibility of cashing out after hitting a bonus in the game (this value states whether a player cashes out after winning a bonus or not), possibility of changing the game after hitting a bonus in the game (this value states whether a player changes a game after winning a bonus or not), available cash (bank) wager correlation (correlation between wager amount and available cash; available cash is the current credit amount available to the player on an EGM (i.e., amount to be paid if the player decided to cash out)), average time between spins (average of the time difference between consecutive spins), standard deviation of time between spins (standard deviation of the time difference between consecutive spins), total cash out, total primary win (sum of all wins resulting from primary spin), average primary win (average win per spin), average secondary wager (average wagers for secondary games in a session), average secondary win (average wins for secondary games in a session), sum of secondary win (total of wins in secondary games in a session), starting cash in (total amount of cash in at the start of the session before he starts playing), additional cash in (total amount of additional cash in after a player starts playing), coin-in to coin-out ratio (coin-in is the total wagers made in a session. coin-out is the total of how much a player has been paid back on those wagers (total winnings)), net loss (the difference between total wagers and total winnings (coin-in-coin-out) in a session), % Loss (the net loss divided by the total wagers), intensity (e.g., wagers per minute in a gameplay session), time of the day segment day/evening (a flag 1 or 0 to specify whether a session was during lunch time or not), cash out occurrence flag (flag to specify whether a player cashed out or ran out of money), cash out to cash in ratio (ratio of cash out to cash in), post loss (ratio of primary wager after a loss to the primary wager before), post win (ratio of the primary wager after a win to the primary wager before), primary wager changes (number of times a player changes primary wager), number of cash ins (number of times a player inserted money in a machine), average cash in, wager to cash in (ratio of the average primary wager to average cash), tradeoff (ratio of average win in primary over average primary wager), secondary to primary (ratio of secondary wager to primary wager), wager to bank ratio (average of the ratio of wager to available cash), primary wager changes/no games, maximum cash in, cash in separated by ticket, note and coin, number of cash outs, max cash out, number of primary wins, list of played games including number of plays, and list of played denominations including number of plays.

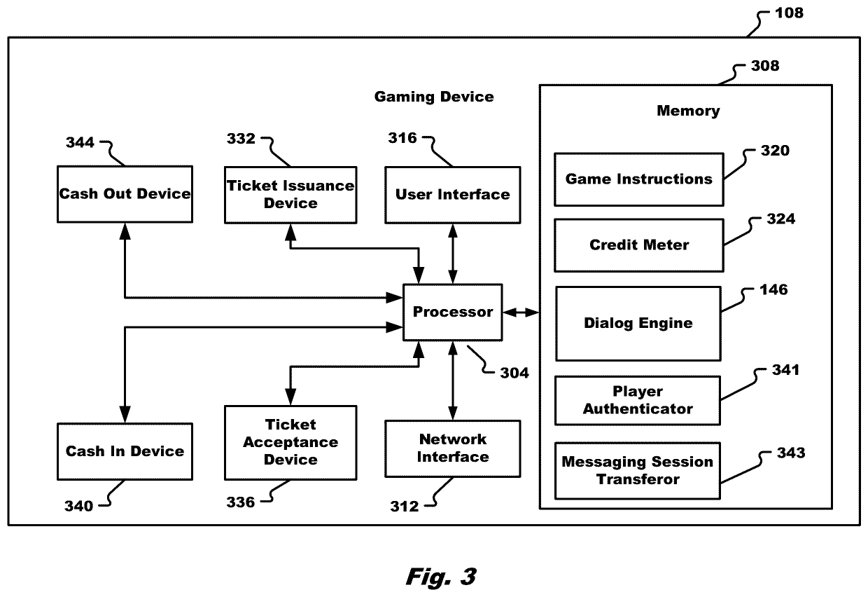

In some aspects, the conversation model 136, when executed by the processor 120, may enable the gaming server 116 to auto-generate and send natural language messages to a player based on such gameplay data to induce a target behavior. While the conversation model may operate using a set of guidelines (e.g., a set of status instructions), the conversation model in most implementations corresponds to a data set that is useable in a neural network and that has been trained by one or more data sets describing conversations or message exchanges between two or more entities. The conversation model may be stored as a model data file or any other data structure that is usable within a neural network or an AI system. As discussed in detail with reference to FIG. 4, the conversation model employs a natural language processing engine and a context generation engine to identify an intent associated with a natural language message received from a player and a message context associated with gameplay data, player information, and/or gaming system behavior model output, respectively, to select, from a plurality of potential natural language messages, a natural language message having a highest likelihood of producing a target behavior of a player recipient of the message.

The neural network used by the conversation model may be, for example, a machine learning network and may include a machine learning architecture. In some aspects, the neural network may be or include an artificial neural network (ANN). In some other aspects, the neural network may be or include any machine learning network such as, for example, a deep learning network, a convolutional neural network, a long-short term memory (LSTM) neural network, or the like. Some or all of the instructions or instruction sets stored in the memory 124 and some functions of the gaming server 116, gaming devices 108, and/or communication devices 144 may be implemented using machine learning techniques. In some cases, the machine learning techniques may include reinforcement learning. In some cases, the machine learning uses unsupervised learning techniques.

In some aspects, the neural network may support various clustering algorithms, such as partitive (or centroidal) or hierarchical clustering, both of which separate data into groups whose members share maximum similarity as defined (typically) by a distance metric. In partitive clustering, clusters are represented by central vectors, distributions, or densities. There are numerous variations of partitive clustering algorithms, but some of the most common techniques include k-means, k-medoids, OPTICS, and affinity propagation. Hierarchical clustering involves creating clusters that have a predetermined ordering from top to bottom and can be either agglomerative (clusters begin as single instances and iteratively aggregate by similarity until all belong to a single group) or divisive (the dataset is gradually partitioned, beginning with all instances and finishing with single instances).

In some aspects, the gaming system behavior model 142, when executed by the processor 120, may calculate or predict as gameplay data or gaming system state, a gaming system behavior of a group of one or more gaming devices with respect to different gameplay events, gameplay decisions, gameplay results, gameplay durations, etc. For example, the gaming system behavior model 142 may calculate or predict the representative response of the group of gaming devices to interactions with current players (e.g., which gaming devices and games are likely to be used over a future time interval, floor occupancy levels, and what revenue will be generated over the future time interval), using gameplay data such as the attributes set forth above. Exemplary gaming system behavior predictions include a number of players in the gaming system venue and/or playing a type of gaming device, player attendance levels in different venue physical areas and/or at different gaming devices, gaming revenue to be realized individually by each gaming device or collectively by a given type of gaming device, from each player or selected group of players, collectively by a type of game, and/or by the gaming system as a whole, number of different players repeatedly playing a gaming device, and the like. The gaming system behavior can be based on summarized gameplay data over a selected time period mathematically combining (e.g., averaging or summing) multiple values of a selected attribute for a set of different gaming machines (over multiple players and multiple gameplay sessions) in the gaming system to provide a representative value for the gaming machines in the set. The gaming system behavior model can be for a type of gaming device (e.g., EGM or EGT) and/or type of game (e.g., slots, roulette, blackjack, poker, keno, etc.).

In some aspects, the dialog engine 146, when executed by the processor 120, may receive and format an outgoing autogenerated message from the conversation model 136 for transmission to the player or receive and remove formatting from an incoming message from a player communication device 144 to enable the message to be analyzed by the conversation model.

In some aspects, the command engine 150, when executed by the processor 120, may receive autogenerated messages in response to a natural language messages received from players that are to be converted into machine commands for a selected gaming device and format and transmit the messages accordingly. Machine commands, for example, can change a setting or configuration of the gaming device.

To enable game event selection, the gaming server 116 can include a pseudorandom number generator (PRNG) or random number generator (RNG) 160. The RNG or PRNG generates a sequence of numbers or symbols that cannot be reasonably predicted better than by random chance. RNGs are typically hardware random-number generators (HRNGs) that generate random numbers, wherein each generation is a function of the current value of a physical environment's attribute that is constantly changing in a manner that is practically impossible to model In contrast, PRNGs generate numbers that only look random but are in fact pre-determined and can be reproduced simply by knowing the state of the PRNG.

The conversation state data 140 may represent a particular state of one or multiple conversations occurring on a communication channel. It can have various values, including active, paused, inactive, etc.

The training data 143 can be any type of historical data that can be used in training the conversation model. The training data structure typically includes an input pattern, an output pattern, and a tag. For example, training data 143 can include pairs (a collection of interactions or conversations (input and output) to be used for training the conversation model, read/patterns that are or could be expected as inputs from players, response patterns that are or could be delivered as outputs from the conversation model to players, regular expressions or patterns that are used to generalize patterns for reading and response (this is mainly used to optimize the training data by making it more generic and avoiding generating static read and write responses), and the tag to group similar text instances and use the same as targeted outputs to train neural networks. Training data, for example, can include conversations between players and the gaming system that have occurred over a particular communication channel relating to a common or different topic, summarized or granular gameplay data for one or more components of the gaming system, and/or player activity data associated with a selected set of players.

In some aspects, the training data 143 may include any data managed by the gaming server 116 with respect to the player profile management instruction set 133, and/or the game management instruction set 132 described herein. For example, the training data 143 may include player histories (e.g., gameplay data, player behavior, sensor data, emotional states, etc.) associated with gameplay sessions at a gaming device(s) 108. In some aspects, the training data 143 may be stored (e.g., in the memory 124, a database, etc.) according to player profile and/or game type. In some other examples, the training data 143 may include player histories associated with previous gameplay decisions (e.g., a decision to gamble, a wager amount, quantity of lines played, a decision to make a bet dependent on another bet outcome (e.g., place a side bet), etc.).

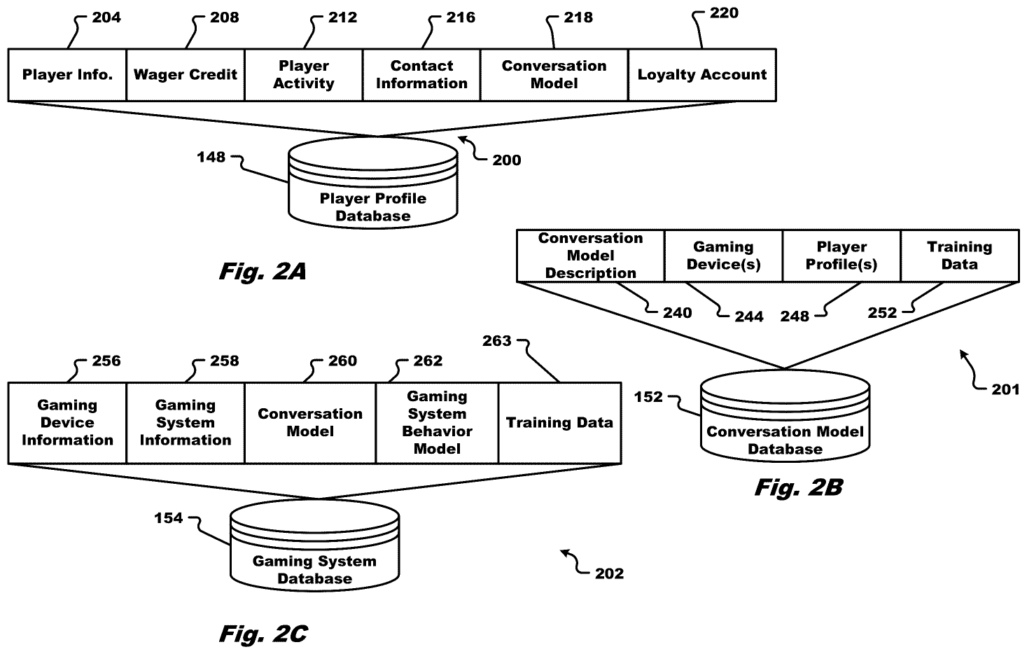

With reference now to FIGS. 2A through 2D, additional details of data structures that are useable in connection with managing the various models (e.g., baseline models, self-evolving player behaviors, modified player behaviors) discussed herein will be described in accordance with at least some embodiments of the present disclosure. It should be appreciated that the data structures depicted and described herein may be stored within a central database or may be distributed among a number of data storage nodes. Alternatively or additionally, some or all of the fields of the data structures may be maintained in devices of the gaming system 100 such as the gaming server 116, a gaming device 108, and/or a communication device 144 without departing from the scope of the present disclosure.

With reference initially to FIG. 2A, details of a data structure 200 that may be maintained as part of a player profile will be described in accordance with at least some embodiments of the present disclosure. The database 148 may be configured to store one or multiple data structures 200 that are used in connection with tracking player progress and gaming history. In some embodiments, the data stored in the data structure 200 may be stored for a plurality of different player profiles or for a single player profile. As a non-limiting example, the data structure 200 may be used to store player loyalty information, player activity information, and the like. Even more specifically, the data structure 200 may include a plurality of data fields that include, for instance, a player information field 204, a wager credit field 208, a player activity field 212, a contact information field 216, conversation model field 218, and a loyalty account field 220.

The player information field 204 may be used to store any type of information that identifies a player or a group of players. In some embodiments, the player information field 204 may store one or more of username information for a player 112, password information for a player account, player status information, accommodations associated with the player 112, and any other type of customer service management data that may be stored with respect to a player 112.

The wager credit field 208 may be used to store data about the available credit of a player 112 with a device, with a sports book, with a casino, and/or with a plurality of casinos. For instance, the wager credit field 208 may store an electronic record of available credit in the player's account and whether any restrictions are associated with such credit. The wager credit field 208 may further store information describing a player's available credit over time, cash out events for the player, winning events for the player 112, wagers placed by the player 112, tickets/vouchers issued to the player 112, and the like.

The player activity field 212 may be used to store historical data for events that occur with respect to the player 112 (e.g., granular or summarized gameplay data associated with gameplay sessions of the player 112). For example, the player activity field 212 may store information associated with the player 112 in relation to an outcome in a game of chance, an outcome in a game of skill, a celebration event for a person other than the player 112, involvement in a celebration event, visits to a predetermined location, gameplay information with respect to a particular game, player interactions with a communication device 144, player interactions (e.g., gameplay decisions, player feedback with respect to a baseline player behavior, etc.) with a gaming device 108, wagers placed by the player 112, tickets/vouchers issued for the player 112, tickets/vouchers redeemed by the player 112, etc. In some other examples, the player activity field 212 may store granular and/or summarized gameplay data from gameplay sessions of the corresponding player 112.

In some aspects, the player activity field 212 may store sensor data (e.g., biometric data, pressure sensor data, etc. described herein) associated with a player in relation to gameplay sessions. For example, the player activity field 212 may store sensor data associated with gameplay data (e.g., gameplay behavior, gameplay decisions, etc.) and/or gameplay events (e.g., gameplay decision events, gameplay outcomes, gameplay recommendations or predictions by a player behavior model linked to the player, etc.).

The contact information field 216 may store information associated with a preferred mode(s) of contact for the player 112 and how such contact can be made. For instance, the contact information field 216 may store information such as an email address, phone number, room number, player loyalty number, address, etc.

The conversation model field 218 may store a description for a conversation model to be used with the corresponding player, such as message and target behavior predictions by the conversation model and hyperparameters and tunable parameters of the conversation model. The field 218 may include a list of conversation models associated with the player profile. For example, the conversation model field 218 may include a list of stored conversation models (e.g., stored at the memory 124 of the gaming server 116, stored at the player profile database 148, stored at the conversation model database 152, stored at the gaming device database 154, etc.). In some examples, for a conversation model stored at a communication device 144 of the player 112, the conversation model field 218 may include identifying information associated with the conversation model, without the model data included in the conversation model.

The loyalty account field 220 may store information regarding the corresponding player's loyalty account status and other information, such as player loyalty tier ranking (e.g., gold, silver, bronze, etc.).

With reference now to FIG. 2B, details of another data structure 201 that may be used within the gaming system 100 will be described in accordance with at least some embodiments of the present disclosure. The database 152 may be configured to store one or multiple data structures 201 that are used in connection with conversation models. Even more specifically, the data structure 201 may include a plurality of data fields that include, for instance, a conversation model description field 240, a gaming device field 244, a player profile field 248, and a training data field 252.

The conversation model field description field 240 may include any information related to a corresponding conversation model. In some aspects, the conversation model field description field 240 may store data (e.g., characteristics, features, use history, modifications, etc.) associated with conversation models described herein. For example, the conversation model field description field 240 may store data associated with baseline models, modified versions of the conversation models, or the like. In some examples, the conversation model field description field 240 may store accuracy or validity information associated with predictions or messages generated by the corresponding conversation model with respect to an action in response to an autogenerated message.

The conversation model field description field 240 may include meta data tags to determine which conversation model(s) are compatible for use with a gaming device 108 and/or player type or loyalty level. For example, the gaming device 108 (or gaming server 116) may determine which data model(s) 142 are compatible for use with a game type implemented at the gaming device 108.

The conversation model field description field 240 can include current values of one or more tunable model parameters or hyperparameters. Exemplary parameters or hyperparameters include in addition to other parameters discussed herein randomness settings, humor level, chattiness level, threshold player preference level to include recent news events, player language, and player culture, threshold level to include game details and other gameplay data, threshold player preference level to include information about events a player may traditionally enjoy/like, threshold player preference level to include information about times of the year (holidays, etc.) a player may traditionally enjoy/like, and threshold player preference level to receive information about the weather or current conditions at the casino in comparison to the weather or conditions where at the player's location.

The gaming device(s) field 244 may store descriptions of the gaming devices, games, game themes, or other gaming system components to which the corresponding conversation model may be applied.

The player profile(s) field 248 may store descriptions of the player profiles identifying players to which the corresponding conversation model may be applied.

The training data field 252 may store training data 143 used to train the corresponding conversation model.

With reference to FIG. 2C, details of a data structure 202 that may be maintained as part of a gaming device profile will be described in accordance with at least some embodiments of the present disclosure. The gaming system database 154 may be configured to store one or multiple data structures 202 that are used in connection with tracking a gameplay mode of a gaming device 108. In some embodiments, the data stored in the data structure 202 may be stored for a plurality of different gaming devices 108 or a single gaming device 108. As a non-limiting example, the data structure 202 may be used to store gaming device information, and the like. Even more specifically, the data structure 202 may include a plurality of data fields that include, for instance, a gaming device information field 256, a gaming system information field 258, a conversation model field 260, a gaming system behavior model field 262, and training data field 263.

The gaming device information field 256 may be used to store any type of information that identifies a gaming device 108 or a group of gaming devices 108. In some embodiments, the gaming device information field 256 may store identification information for a gaming device 108 (e.g., a unique serial number assigned to the gaming device 108) and any other type of gaming device management data that may be stored with respect to a gaming device 108.

The gaming system information field 258 may be used to store any type of gameplay and other gaming information including granular and/or summarized gameplay data, gaming system (e.g., casino floor) map showing gaming device location and current usage (e.g., heat map), and the like.

The conversation model field 260 may include a list of conversation models that may be used with the corresponding gaming device. For example, the conversation model field 260 may include a list of stored conversation models (e.g., stored at the memory 124 of the gaming server 116, stored at the conversation model database 152, stored at the player profile database 148, stored at the gaming device database 154, etc.).

The gaming system behavior model field 262 may store gaming system model decisions or predictions and hyperparameters and tunable parameters and may include a list of gaming system behavior models. For example, the gaming system behavior model field 262 may include a list of stored gaming system behavior models (e.g., stored at the memory 124 of the gaming server 116, stored at the player profile database 148, stored at the gaming device database 154, etc.).

In some aspects, the training data field 263 may store training data for the gaming system behavior model identified in the field 262. While the training data can take many forms, it typically stores aggregated or summarized gameplay data.

In some embodiments, gameplay data include not only any of the gameplay data 400 noted above but also alternative or additional features including: a credit amount at the start of a gameplay session (e.g., ‘SumCashInAmount’), a credit amount at the end of a gameplay session (e.g., ‘SumCashOutAmount’), quantity of wager adjustments during a temporal period and/or during a gameplay session (e.g., ‘No. of bet changes’), a ratio of a wager amount to a player bankroll (e.g., ‘Wager-Bank-Ratio’), gameplay duration associated with gameplay session (e.g., ‘TimePlayed’), average wager amount for a primary game (base game) (e.g., ‘AverageWagerPrimary’), an average win amount associated with a primary game (e.g., ‘AveragePrimaryWinAmount’), quantity of primary games played during a temporal period and/or during a gameplay session (e.g., ‘No.PrimaryGamesPlayed’), quantity of secondary games (bonus games) played during a temporal period and/or during a gameplay session (e.g., ‘No. SecondaryGamesPlayed), or the like.

In some aspects, the gameplay data may be data (e.g., gameplay data, sensor data, etc.) collected directly via a gaming device 108 associated with a player and a gameplay session. The data may be collected via a central game management system, a player tracking system, a casino management system, a controller/data aggregator (e.g., iLink-type device), or the like. The tracked inputs may include active inputs (e.g., a gameplay decision, a button press, a handle pull, etc.) and/or passive inputs (e.g., a measured biometric parameter) In some examples, the gaming device 108 may track and forward gameplay results (e.g., resulting game outcomes).

In some embodiments, the summarized gameplay data 400 is mathematically derived (e.g., by averaging or otherwise aggregating) over a selected time interval from the values of each of the data fields for all gameplay sessions of a group of gaming devices. In other embodiments, fewer or consolidated fields are used. Exemplary attributes for aggregated (detailed) or summarized gameplay for each gaming device over a selected time period include record identifier (Recordid), upload time stamp (UploadTimestamp), gaming device identifier (e.g., MachineSerialNumber), pull local timestamp (PullLocalTimestamp), vendor (e.g., casino) name (VendorName), (casino) currency code (CurrencyCode), game identifier (GameId), game name (GameName), denomination (Denomination), return to player (Rtp) base percentage RtpBasePercentage), total coin in credits (TotalCoinInCredits), total jackpot credits (TotalJackpotCredits), pull date (PullDate), time since previous pull (TimeSincePreviousPull), total coin in currency (TotalCoinInCurrency), total coin out currency (TotalCoinOutCurrency), total jackpot currency (TotalJackpotCurrency), total net win currency (TotalNetWinCurrency), total theoretical win currency (TotalTheoreticalWinCurrency), total games played (TotalGamesPlayed), total players played (TotalPlayersPlayed), and the like.

In some aspects, the conversation model and gaming system behavior model fields 260 and 262 may store data (e.g., characteristics, features, use history, modifications, etc.) associated with the respective model. For example, the fields 260 and 262 may store data associated with baseline models, modified versions of the models, or the like. In some examples, the fields may store accuracy information associated with decisions and predictions generated by the model with respect to an action or event (e.g., for the conversation model (message or target behavior of player recipient) and for the gaming system behavior model (player occupancy levels and locations in the gaming system and revenue realized.

With reference to FIG. 2D, details of a data structure 205 that may be maintained as part of a message conversation (or thread) profile will be described in accordance with at least some embodiments of the present disclosure. The player message database 155 may be configured to store one or multiple data structures 205 that are used in connection with an identified conversation. In some embodiments, the data stored in the data structure 205 may be stored for a plurality of different conversations or a single conversation. The data structure 205 tracks the conversations and data associated with a specific player's conversation state. As a non-limiting example, the data structure 205 may include a plurality of data fields that include, for instance, a thread identifier field 270, participant address(es) field 274, conversation state field 278, message(s) field 282, generated by gaming system? field 286, and message validity field 290.

The thread identifier field 270 may be used to store any type of information that identifies a conversation or a group of related conversations (e.g., a first conversation on a first device (e.g., a communication device 144 or gaming device 108) is transferred to a second conversation on a second device (e.g., the other of a communication device 144 or gaming device 108) and the second conversation is transferred to a third conversation back on the first device).

The participant address(es) field 274 may be used to store any type of information that identifies the communication devices involved in the corresponding thread ID. The information typically includes the electronic addresses of each endpoint (e.g., communication device 144 or gaming device 108 and gaming server 116) to the conversation. The electronic address can be of any form so long as the address uniquely identifies the endpoint.

The conversation state field 278 may store the conversation state data 140 for the corresponding thread ID.

The message(s) field 282 may store the player and autogenerated gaming system originated messages in the conversation corresponding to the thread ID. The message(s) may be constantly updated, revised, edited, or deleted by the conversation model as the conversation model engages in more conversations with players.

In an example, the stored messages may be limited by memory limitations. For example, messages may be stored only over the last X messages exchanged, where X is a variable parameter, or the messages are deleted after an associated timestamp falls outside of a defined time window of relevance.

The generated by gaming system? field 286 may store a binary value indicating whether or not the associated message was generated by the player or autogenerated by the conversation model.

The message validity field 290 may store a binary value for autogenerated messages indicating whether or not the associated autogenerated message was valid/appropriate or invalid/inappropriate. As noted, the conversation model can determine this value based on player input or whether or not a predicted target behavior of the player associated with the autogenerated message occurred.

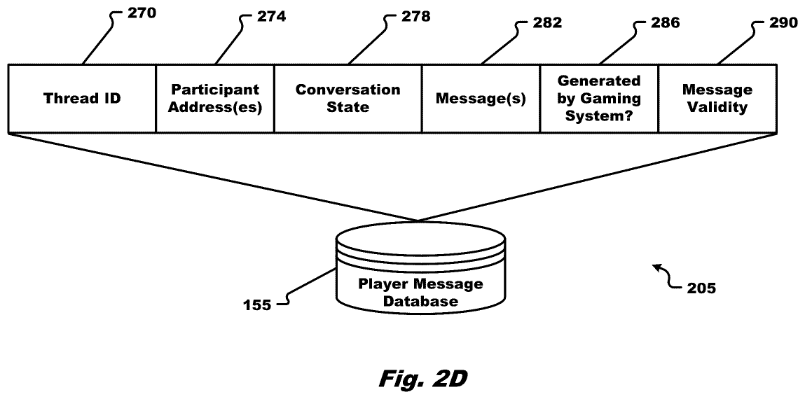

With reference now to FIG. 3, additional details of a gaming device 108 will be described in accordance with at least some embodiments of the present disclosure. While depicted as a gaming device 108, it should be appreciated that some or all of the components of the gaming device 108 may be included in a mobile device 144 described herein without departing from the scope of the present disclosure.

The gaming device 108 is depicted to include a processor 304, memory 308, a network interface 312, a user interface 316, a ticket issuance device 332, a ticket acceptance device 336, a cash-in device 340, and a cash out device 344. In some embodiments, the processor 304 may include example aspects of the processor 120. In other words, the processor 304 may correspond to one or many microprocessors, CPUs, microcontrollers, or the like. The processor 304 may be configured to execute one or more instruction sets stored in memory 308.

The network interface 312 may include example aspects of network interface 128. The nature of the network interface 312, however, may depend upon whether the network interface 312 is provided in a gaming device 108 or a communication device 144. Examples of a network interface 312 include, without limitation, an Ethernet port, a USB port, an RS-232 port, an RS-485 port, a NIC, an antenna, a driver circuit, a modulator/demodulator, etc. The network interface 312 may include one or multiple different network interfaces depending upon whether the gaming device 108 is connecting to a single communication network 104 or multiple different types of communication networks 104. For instance, the gaming device 108 may be provided with both a wired network interface and a wireless network interface without departing from the scope of the present disclosure.

The user interface 316 may correspond to any type of input and/or output device that enables the player 112 to interact with the gaming device 108. As can be appreciated, the nature of the user interface 316 may depend upon the nature of the gaming device 108. For instance, if the gaming device 108 is a traditional mechanical reel slot machine, then the user interface 316 may include one or more mechanical reels with symbols provided thereon, one or more lights or LED displays, one or more depressible buttons, a lever or “one armed bandit handle,” a speaker, or combinations thereof. If the gaming device 108 is a digital device, then the user interface 316 may include one or more touch-sensitive displays, LED/LCD display screens, etc. In some cases, the user interface 316 may include a combination of a physical interface (e.g., mechanical reels, depressible buttons, a lever, etc.) and other user interfaces (e.g., touch-sensitive displays, LED/LCD display screens, etc.). In some cases, the user interface 316 may include a biometric scanning device (e.g., a fingerprint scanner) supportive of biometric inputs by a user. In some examples, the user interface 316 may include any combination of sensors 145 described with reference to FIG. 1 (e.g., an image sensor, an eye tracking sensor, a heart rate sensor, an infrared sensor, an audio sensor, a pulse sensor, an oxygen sensor, a temperature sensor, a pressure sensor, a touch screen sensor, a vibration sensor, a motion sensor, an accelerometer, etc.).

In some examples, the user interface 316 may include an interactive service window. Machine-to-machine communications and player input can be improved using the interactive service window. The service window has an electronic address on the gaming or communications network different from an address of the host gaming device itself, to exchange directly in bound and out bound electronic messages with the communication server 116 and display content provided by the gaming server 116 to the player. The service window can slide into view either from the right, left, or top of the gaming display and offer interactive touch screen capabilities to the player. The content of the game theme on the display is unaffected or independent of the service window, which can be opened or closed by the player. The service window can be a fully interactive touch screen menu that players can use to activate bonus features, receive and send messages to the gaming server 116, and view messages or advertisements from the gaming server 116.

The memory 308 may include example aspects of memory 124. For instance, the memory 308 may include one or multiple computer memory devices that are volatile or non-volatile. The memory 308 may be configured to store instruction sets that enable player interaction with the gaming device 108, that enable game play at the gaming device 108, and/or that enable coordination with the gaming server 116. Examples of instruction sets that may be stored in the memory 308 include a game instruction set 320, a credit meter 324, a dialog engine instruction set 146, player authenticator instruction set 341, and messaging session transferor instruction set 443.

In some embodiments, the game instruction set 320, when executed by the processor 304, may enable the gaming device 108 to facilitate one or more games of chance or skill and produce interactions between the player 112 and the game of chance or skill. In some embodiments, the game instruction set 320 may include subroutines that present one or more graphics to the player 112 via the user interface 316, subroutines that calculate whether a particular wager has resulted in a win or loss during the game of chance or skill, subroutines for determining payouts for the player 112 in the event of a win, subroutines for exchanging communications with a connected server (e.g., game management server, gaming server 116, or the like), subroutines for enabling the player 112 to engage in a game using their communication device 144, and any other subroutine or set of instructions that facilitate gameplay at or in association with the gaming device 108.

The credit meter 324 may correspond to a secure instruction set and/or data structure within the gaming device 108 that facilitates a tracking of activity at the gaming device 108. In some embodiments, the credit meter 324 may be used to store or log information related to various activities of a player 112 and events that occur at the gaming device 108. The types of information that may be maintained in the credit meter 324 include, without limitation, player information, available credit information, wager amount information, and other types of information that may or may not need to be recorded for purposes of accounting for wagers placed at the gaming device 108 and payouts made for a player 112 during a game of chance or skill played at the gaming device 108.

In some embodiments, the credit meter 324 may be configured to track coin in activity, coin out activity, coin drop activity, jackpot paid activity, bonus paid activity, credits applied activity, external bonus payout activity, ticket/voucher in activity, ticket/voucher out activity, timing of events that occur at the gaming device 108, and the like. In some embodiments, certain portions of the credit meter 324 may be updated in response to outcomes of a game of chance or skill played at the gaming device 108. In some embodiments, the credit meter 324 may be updated depending upon whether the gaming device 108 is issuing a ticket/voucher, being used as a point of redemption for a ticket/voucher, and/or any other activity associated with a ticket/voucher. Some or all of the data within the credit meter 324 may be reported as gameplay data to the gaming server 116, for example, if such data applies to a centrally-managed game and/or a status of a ticket/voucher.

In some embodiments, the player authenticator instruction set 341, when executed by the processor 304, may enable the gaming device 108 to authenticate that a player is authorized to use a communication device 144 before transmitting the natural language communication.

In some embodiments, the messaging session transferor instruction set 343, when executed by the processor 304, may enable the gaming device 108 to cause the communication device 144 of the player to transfer an active communication session to the gaming device or vice versa. The player may initiate the transfer by activation of a triggering signal from a first device (the communication device 144 or gaming device 108). In response, the gaming device 108 or server 116 launches a new messaging session with a second device (the other of the communication device 144 or gaming device 108) and transferring the context of the messaging session (e.g., player identifier, type of messaging session (e.g., instant messaging chat session), the identity of the gaming device 108, and the electronic address of the communication device 144), and other information) corresponding to the original messaging session to the new messaging session. The messaging session can be continued via use of the first device as a proxy for the second device. The transfer may be automatic based on player location relative to the gaming device 108 as sensed by the sensor.

The gaming device 108 may be provided with appropriate hardware to facilitate acceptance and issuance of tickets/vouchers. Specifically, the gaming device 108 may be provided with a ticket acceptance device 336 that is configured to accept or scan physically-printed tickets/vouchers and extract appropriate information therefrom. In some embodiments, the ticket acceptance device 336 may include one or more machine vision devices (e.g., a camera, IR scanner, optical scanner, barcode scanner, etc.), a non-visual scanning device (e.g., an RFID reader, an NFC reader), a physical ticket acceptor, a shredder, etc. The ticket acceptance device 336 may be configured to accept physical tickets and/or electronic tickets without departing from the scope of the present disclosure. An electronic ticket/voucher may be accepted by scanning a visual code (e.g., a one-dimensional barcode, a two-dimensional barcode, any other type of barcode, a quick response (QR) code, etc.) displayed on a printed ticket/voucher or a communication device 144, for example. In another example, an electronic ticket/voucher may be accepted by scanning a tag (e.g., an RFID tag, an NFC tag, a contactless smart card, or the like) storing the ticket/voucher information.

The ticket issuance device 332 may be configured to print or provide physical tickets/vouchers to players 112. In some embodiments, the ticket issuance device 332 may be configured to issue a ticket/voucher consistent with an amount of credit available to a player 112, possibly as indicated within the credit meter 324. In some cases, the ticket/voucher may be an e-TITO voucher including a reprogrammable electronic display and an RFID tag.

The cash-in device 340 may include a bill acceptor, a coin acceptor, a chip acceptor or reader, or the like. In some embodiments, the cash-in device 340 may also include credit card reader hardware and/or software. In some aspects, the cash-in device 340 may include one or more machine vision devices (e.g., a camera, IR scanner, optical scanner, barcode scanner, etc.) or non-visual scanning devices (e.g., an RFID reader/writer, an NFC reader/writer).

The cash-out device 344, like the ticket issuance device 322, may operate and issue cash, coins, tokens, or chips based on an amount indicated within the credit meter 324. In some embodiments, the cash-out device 344 may include a coin tray or the like and counting hardware configured to count and distribute an appropriate amount of coins or tokens based on a player's 112 winnings or available credit within the credit meter 324. In some aspects, the cash-out device 344 may include one or more machine vision devices or non-visual scanning devices.

In some embodiments, the conversation model may be stored in the memory 308 of the gaming device 108. In this configuration, the memory 308 may be configured to store instruction sets, neural networks, and other data structures (e.g., depicted herein) in addition to temporarily storing data for the processor 304 to execute various types of routines or functions. For example, the memory 308 may be configured to store program instructions (instruction sets) that are executable by the processor 304 and provide functionality of a machine learning engine described herein. The machine learning engine may include example aspects of the machine learning engine described with reference to FIG. 1.

Aspects of the present disclosure may be applied to game types other than those associated with gaming devices 108. For example, the gaming system 100 may support application of the various models described herein to a sports betting environment. In some aspects, the gaming server 116 (e.g., machine learning engine 141) may support processing any combination of data associated with a sporting event (e.g., athlete performance, athlete performance statistics, team performance, team statistics, previous game results, etc.) and player decisions (e.g., wager amounts, wager parameters, etc.) associated with the sporting event. The gaming server 116 may generate any number of conversation models corresponding to player conversations in relation to a sporting event. In some cases, the gaming system 100 may support player conversations associated with sports wagers such as micro events (e.g., micro-betting).

Further details of the conversation model 136 will now be described with reference to FIG. 4. As noted, the conversation model 136 utilizes machine learning and has access to training data 143 to initially train behaviors of the conversation model. The conversation model 136 may also be configured to learn from further conversations and gaming system state information (e.g., gameplay data, player activity information, and gaming system behavior model output) based on feedback, which may be provided in an automated manner (e.g., via recursive learning neural network) and/or human-provided manner (e.g., by players or gaming system personnel confirming or denying that a particular natural language message prepared by the conversation model was valid and/or appropriate for a particular natural language message received from a player 112.

A learning/training module 408 of the conversation model 136 may have access to and use the context generation engine 412 and natural language processing engine 416. The context generation engine 412 and natural language processing engine 416 may be built and updated by the training/learning module 408 based on the training data 143 and feedback 420. The learning/training module 408 may also be configured to access information from the player message database 155 for purposes of building and updating autogenerated natural language messages in the database 155, which effectively stores autogenerated natural language messages that have been previously provided by the conversation model 136 and have been identified as valid or appropriate under the circumstances (e.g., based on a positive response from a player 112 and/or based on administrative user inputs and/or based on a deviation of a predicted target player behavior from an actual player behavior identified in response to the message). Messages within the database 155 may constantly be updated, revised, edited, or deleted by the learning/training module 408 as the conversation model 136 engages in more conversations with players 112. At a high level, the conversation model uses pattern matching to classify the text and produce a suitable response for players. Although any structure may be employed, a standard structure of these patterns is Artificial Intelligence Markup Language (AIML).

In some aspects, components of the learning/training module 408 may be provided in a separate machine learning engine (e.g., at server, for example, the gaming server 116) in communication with the gaming device 108.

In some embodiments, the context generation engine 412 may receive gameplay data 400, player information 404, and/or gaming system behavior model 142 input (collectively gaming system state information) to determine a context for the conversation. The context can include events exterior to the content of the messaging session itself. Context, for instance, can include concurrent events in a gaming session of the player, concurrent events in the gaming system other than the gaming session, events predicted by the gaming system behavior model 142 temporally proximal to the message to be autogenerated, and the like. As shown by the examples below, context can be used by the recommendation engine 428 as an additional input to determining a most desirable autogenerated message from a plurality or library of potential autogenerated messages.

In some embodiments, the natural language processing (NLP) engine 416 may include an intent classifier 420, sentiment analyzer 421, entity extractor 424, and pre-processor 426. The entity extractor 424 identifies keywords in the player's message.

The pre-processor 426, in text-based messaging, can normalize the message data by converting all the message data into either upper or lower case and correcting grammatical and spelling mistakes to avoid misrepresentation and misinterpretation of words, performing named entity recognition in the message data such as by grouping words into categories, performing dependency parsing of the message data to identify objects and subjects, verbs, nouns, and common phrases in the message data to find dependent and related terms relevant to the player's intent, converting the pre-processed message data into a series of tokens, which typically are single words or expressions, and stemming the tokenized stream by identifying similarities between words with common root words (to reduce a bag of words by associating similar words with corresponding root words).

The entity extractor 424 generates the bag of words by converting words in the stemmed tokenized stream into numbers through generating vector embeddings from the tokens generated previously to provide an input to the intent classifier to understand the written text and identify an intent.

The intent classifier 420 identifies an intent of the player from the keywords and maps an intent of the message received from the player against a type of action to be performed by the conversation model 136. The intent can be determined by a content-based topic classification and a topic confidence score for the message that the topic classification is correct. The intent classifier 420 can base the topic classification score on whether each potential topic classification identified in the player's message is related to a concurrent context identified by the context generation engine 412. To assist topic mapping to the context, a common metadata syntax can be used to describe both context and the topic classifications. Stated differently, a higher topic classification score is assigned to a topic classification that maps successfully to the identified context and a lower topic classification score is assigned to a topic that does not map successfully to the identified context. For example, for a text having a topic classification relating to slots, the classification score is increased when the player is concurrently playing a slot game and decreased when the player is concurrently interacting with a sports betting application.

By way of illustration, the intent classifier can employ any suitable algorithm, such as Multinomial Naïve Bayes (MNB), Support Vector Machines (SVM), or a neural network classifier to identify the intent classifications and map the intent classifications to an action of the conversation model. In an MNB example, word matches are found for the keywords for each class of intent. The classification score identifies the class with the highest term matches and thus signifies which intent is most likely to the message. In a neural network example, the stemmed stream of tokens is used as input for a neural network. The weighted connections are then calculated by different iterations through the training data thousands of times, each time improving the weights to make it accurate. The classification score is derived from the weighted connections.

The sentiment analyzer 421 can work with the intent classifier 420 to perform sentiment and/or tone analysis to interpret the sentiment of the player's message by reading into the entities, themes and topics, particularly in light of the identified context. The sentiment analyzer 421 groups text from users and classifies it in various categories, which typically include at least positive, negative, and neutral. In some implementations, the analyzer can detect other sentiment states such as anger, happiness, disgust, fear, sadness, curiosity, excitement, and other range of emotions. The analyzer can use pre-labeled words that have already been categorized into these categories. When a player provides a natural language message, the sentiment analyzer analyzes the message and returns a score or rating for the confidence level for understanding to which sentiment classification or category the message belongs. As in the case of the intent classifier 420, the sentiment analyzer 421 can base the sentiment classification score for a message on whether each potentially applicable emotional category identified in the player's message is related to a temporally concurrent context identified by the context generation engine 412. To assist topic mapping to the context, a common metadata syntax can be used to describe both context and the sentiment classifications. Stated differently, a higher sentiment confidence score is assigned to a sentiment classification that maps successfully to the identified context and a lower sentiment confidence score is assigned to a sentiment classification that does not map successfully to the identified context. For example, a higher confidence score for “excitement” is assigned to a natural language message from a player regarding his experience with a gaming device or game or theme on the gaming device when concurrent context indicates a winning outcome for the player in a gaming session on the gaming device than when concurrent context indicates a losing outcome for the player in the gaming session. After detection and classification, the sentiment analyzer can present output that enables the conversation model to autogenerate a natural language message with grammar and syntax (e.g., formatting and punctuation such as the use of italics, caps, bold font, differently colored font, font size and type, etc., to emphasize a target sentiment or tone classification) aligned with or responsive to the sentiment or tone classification associated with the player's text and/or otherwise direct the conversation in a more positive or opportunistic direction. For example, for a text with a high positive score (joy+happiness), the conversation model can use that as an opportunity for a casino game recommendation and for a text with a high negative score (anger+unhappiness), the conversation model can use that as an opportunity to award the player a comp offering.

In some embodiments, the conversation model 136 may include a recommendation engine 428 that has access to the database 155 and selects appropriate response recommendations from the database 155 based on intent and sentiment classifications and corresponding classification scores and dialog inputs 430 from a dialog engine 146. As shown in FIG. 2, the dialog inputs 430 can be in the form of real-time chat data and/or in the form of conversation state 140 information. The real-time chat data may correspond to the content of a message received on a communication channel from a player's communication device 144. In other words, the dialog engine 146 may be configured to retrieve message content from a digital communication channel and provide such content to the conversation model 136 in the form of dialog inputs 430.

Using the intent and sentiment classifications and corresponding classification scores, dialog inputs, and the database 155, the recommendation engine 428 may be configured to recommend one or multiple responses to a response generator 432. The response generator 432 may be configured to provide a selected response as the outgoing message 434 to the dialog engine 146 for sending on the appropriate communication channel. Stated another way, the dialog engine 146 may be responsible for managing a state of a conversation and may provide the mechanism by which the conversation model engages with the communication channel and the player 112. For instance, the dialog engine 146 may produce a response message for a chat channel over which a player 112 previously transmitted a message. The interactions between the conversation model 136 and player 112 may be with different virtual objects (e.g., gaming devices, games, game themes, etc.) of the gaming system and the status of the interaction may be determined by the dialog engine 146, which updates the conversation state 140 accordingly.

To achieve this capability, the conversation model 136 may constantly be provided training data from conversations and interactions between the gaming system 100 and players 112 that have occurred over a particular communication channel. It may be possible to train a conversation model to have a familiarity with a particular gaming device, game and/or theme and/or player (e.g., by training the conversation model not only with conversations but also gameplay data 400, player information 404, and/or gaming system behavior model output). Accordingly, it should be appreciated that the gaming system 100 may include a plurality of conversation models of different types without departing from the scope of the present disclosure.

The conversation model can be assigned to a player based on one or more criteria or player parameters stored in the player profile database 148, conversation model database 152, gaming device database 154, and player message database 156. Such criteria can include one or more of the following: player preferences, loyalty account status, player social media data (e.g., learn what the player likes and dislikes), and player casino or gameplay activity or data (e.g., game wagers, wins, types of games, player skill level (e.g., poker skill, sports wagering skill, etc.), sports wagering, shopping, dining, hotel service use, night club use/activity, spa use/activity, events attended (e.g., concerts, etc.), dates/times of historical visits to the casino), weather conditions at the casino or where the player lives, and the like.

By way of illustration, a conversation model configuration is associated with a player loyalty account with a casino. In a similar embodiment, the gaming device has a basic model for all players, but certain loyalty club players get special models, such as gold level players interacting with a gold player model unique to their preferences. Stated differently, players of a first loyalty club level interact with a first conversation model while players of a higher second loyalty club level interact with a second conversation model. The conversation model can be configured differently for different player loyalty accounts having a common loyalty club level such that one gold club level member interacts with a first conversation model while another gold club level member interacts with a different conversation model. Stated differently, a first players of a first loyalty club level interacts with a first conversation model while another player of the first loyalty club level interacts with a second conversation model.

The conversation model can initiate a messaging session or conversation in response to a gaming system stimulus. Examples of stimuli include one or more of the following: expiration of an amount of time or time threshold, occurrence of a game event such as a win on a game or gaming device, occurrence of a gaming system event such as a lucky coin bonus, a random basis such as generated by the PRNG/RNG 160, after expiration of an amount of time or time threshold of the player not playing the game or not visiting the casino, when the system determines, based on player activity, that the player usually will visit the casino around that time (such as always during that time of year, or around a particular holiday, or for a particular recurring event, such as New Years, etc.) and the like.

A number of examples will now be described to illustrate aspects of the present disclosure. While particular conversations are shown for ease of description, it should be appreciated that embodiments of the present disclosure are not so limited. Moreover, it is to be understood that the user interface is not limited to a user interface of a player communication device 144 but could be a user interface of a gaming device, depending on the implementation. In the examples, “P” refers to the player interacting with the gaming server 116 “G” over a digital communication channel (e.g., a chat communication channel). It should be appreciated that this communication channel could correspond to any type of asynchronous communication channel and does not necessarily need to correspond to a communication channel that is accessed via a chat application.

In a first example in accordance with at least some embodiments of the present disclosure, the gaming system tracks a player's movement through the casino floor. In response to the player moving into proximity of a sports betting gaming device, the conversation model is triggered to send a natural language message to the player's communication device 144, such as “Suzie, last time you picked the Raiders and won $250. Will they win this week? Come on in and let me know!”.

In another example in accordance with at least some embodiments of the present disclosure, the gaming system determines that the player has not visited the casino in a threshold period of time. The expiration of the threshold period of time triggers the communication model to send a natural language message to the player's communication device 144 such as “Bob, somebody just hit the jackpot! It wasn't you? When are coming back to the Mirage?”.

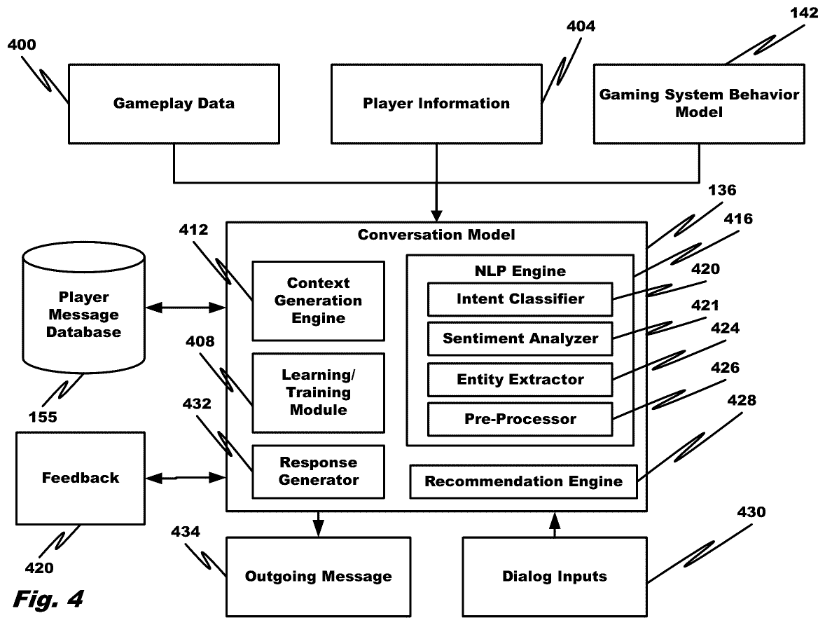

With reference to FIG. 5, another example of the capabilities and functions of the conversation will be discussed in accordance with at least some embodiments of the present disclosure. Specifically, FIG. 5 depicts a screen shot of a graphical user interface 500 of a player communication device 144-b. The player 112 walks into the casino and receives a natural language message (not shown) from the conversation model welcoming her. The awareness of the player's entry to the casino can be determined from a connection of the player's communication device 144-b with the casino's WiFi network and mapping the communication device's identification information to the player information 404 stored in the player profile database 148. In response, the player, at a timestamp of Jan. 9, 2023, 5:36 pm, sends a natural language message 504 asking what games are new. The conversation model, based on gaming system information 258 in the gaming system database 154 and stored player information for the player, responds, at a timestamp of Jan. 9, 2023, 5:37 pm, with an autogenerated natural language message 508 “Suzie, new games are All Star III and S3000 Classic from IGT. Come over and play.” Shortly thereafter at timestamp Jan. 9, 2023, 5:57 pm, the player responds with a natural language message 512 “What's the current jackpot?”. The conversation model, using awareness of gameplay data responds with an additional natural language message(s) 516 providing gaming system-related information requested by the player.

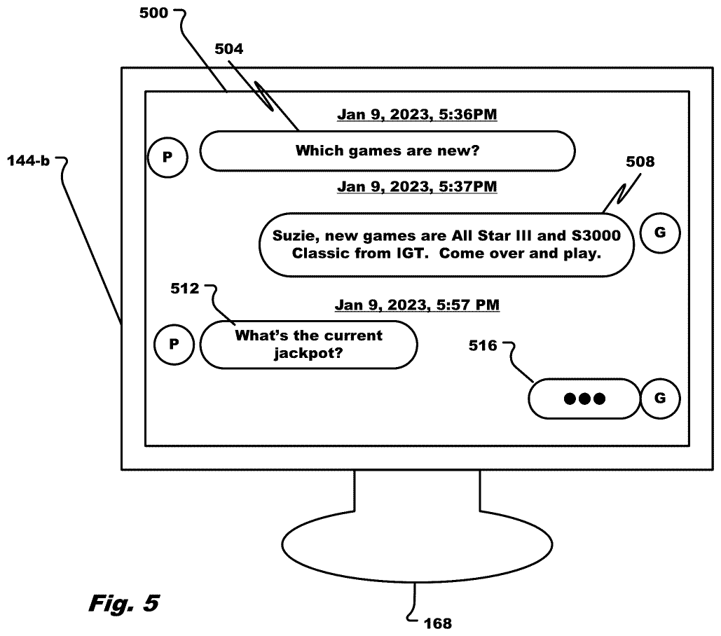

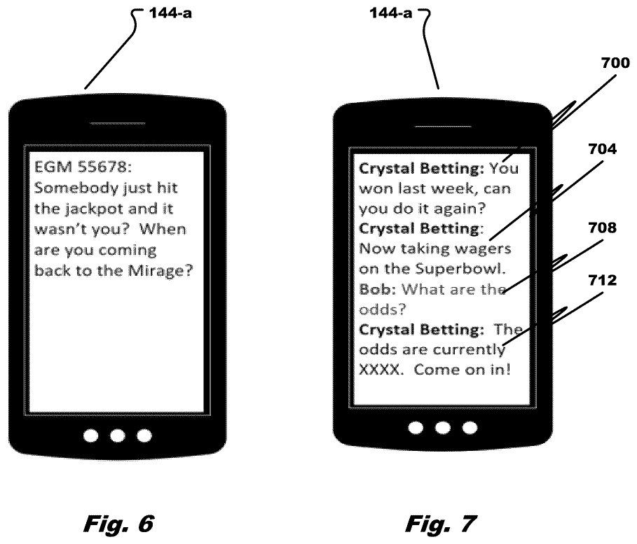

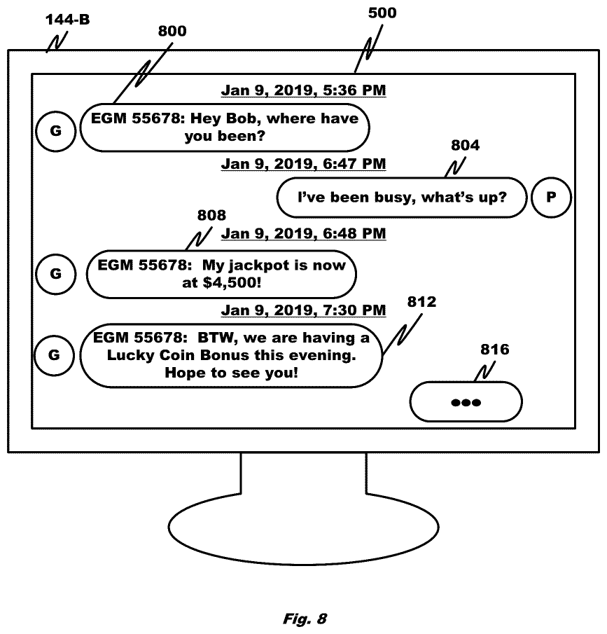

In another example in accordance with at least some embodiments of the present disclosure, the gaming system determines that the player has not visited the casino in a threshold period of time. The expiration of the threshold period of time triggers the communication model to send a natural language message to the player's communication device 144-a on behalf of an EGM previously played by the player, namely EGM 55678 (which prior interaction is stored in the player activity field 212). It is to be appreciated that any identifier can be given to the EGM, including a name of a game or theme hosted by the EGM or a name given to the EGM by the player (e.g., “Suzie's favorite EGM”). In response to expiration of the threshold period of time, the conversation model, based on gameplay data 400, selects a message relating to a recent gaming event. With reference to FIG. 6, the user interface or display of the communication device 144-a displays the natural language message “EGM 55678: Somebody just hit the jackpot and it wasn't you? When are you coming back to the Mirage?”.

In another example in accordance with at least some embodiments of the present disclosure, the gaming system determines that the player has not visited the casino in a threshold period of time. The expiration of the threshold period of time triggers the communication model to send an autogenerated natural language message to the player's communication device 144-a on behalf of a sports betting application on a gaming device previously played by the player, namely “Crystal Betting” (which prior interaction is stored in the player activity field 212). It is to be appreciated that any identifier can be given to the sports betting application. In response to expiration of the threshold period of time, the conversation model, based on player information 404 and gameplay data 400, sends an autogenerated natural language message 700 relating to a prior player activity: “You won last week, can you do it again?”. When the player fails to respond, the conversation model, after expiration of a second different threshold period of time or after an interrupt associated with occurrence of a gaming event, sends a further natural language message 704 based on gameplay data 400″ “Now taking wagers on the Superbowl.” In response, the player sends a natural language message 708: “What are the odds?” In response, the conversation model, based on gameplay data 400, sends a further autogenerated natural language message “The odds are currently XXXX. Come on in!” As illustrated by this example, the player is able to text to the gaming device and the gaming device responds based on the configuration of the gaming device using the conversation model 136 and/or gaming system behavior model 142.

In other embodiments, the player can have a conversation with an application (virtually via the conversation model on the gaming server) on the gaming device instead of the gaming device itself. For example, a player might have one chat session via a first conversation model hosted on the gaming server with the game “Lucky Larry” on the gaming device and another distinct session via a second conversation model with another game “Wheel of Fortune” on the same gaming device. Other applications include not only sports wagering applications but also interactions with the service window on the gaming device.

In some embodiments, the gaming system can use the conversation model to send a comp or other award to the player to increase player engagement. For example, the gaming system recognizes from linked entries in the player profile database that a player is married, and the spouse is also playing, so the comp offer is sent by natural language messages sent by multiple conversation models to both spouses.

In some embodiments, autogenerated natural language messages could also be used to allow the operator to link player tracking or location status to budgets, tiers, and events tied to the player activity.

In some embodiments, the conversation model responds differently or includes real time events when the player is at a casino or is actively playing the gaming device or game theme. For example, the conversation model, on behalf of the game, might text congratulations to the player upon occurrence of a game event (e.g., “Nice jackpot Bob!”, or “Why did you hold the 9 and not the Jack!?!?!?!”) while he or she is playing or post the congratulations on a social media site associated with the player.

In another example in accordance with at least some embodiments of the present disclosure, the gaming system determines that the player has not visited the casino in a threshold period of time. The expiration of the threshold period of time triggers the communication model to send a natural language message 800 to the player's communication device 144-b on behalf of a gaming device (identified as EGM 55678) previously played by the player (which prior interaction is stored in the player activity field 212). In response to expiration of the threshold period of time, the conversation model, based on player information 404 and gameplay data 400, sends a natural language message 800 on behalf of the gaming device relating to a prior player activity: “Hey Bob, where have you been?”. In response, the player sends a natural language message 804: “I've been busy, what's up?”. In response, the conversation model, based on gameplay data 400 and on behalf of the gaming device, sends an autogenerated natural language message 808: “My jackpot is now $4,500!”. When the player fails to respond, the conversation model, after expiration of a second different threshold period of time or after an interrupt associated with occurrence of a gaming event, sends, on behalf of the gaming device, a further natural language message 812 based on gameplay data 400: “BTW, we are having a Lucky Coin Bonus this evening. Hope to see you!” As shown by ellipse 816, the conversation continues.

In one embodiment, the player can text the conversation model to reserve a gaming device that is the intended message recipient. This feature might be available only for certain players, such as gold club members. The player texts the conversation model, on behalf of the gaming device: “Save the seat for me, OK?”. The conversation model, on behalf of the gaming device, may respond by an autogenerated natural language message: “Sure, the machine will be saved for you for 5 minutes” and causes the command engine 150 to lock the gaming device such that other players cannot use it. If gameplay data 400 indicates that the gaming device is busy, the conversation model, on behalf of the gaming device, may respond by an autogenerated natural language message: “Sorry, but another player is playing right now”. The player might be able to reserve the gaming device in the future such as the player texting: “Save the seat for me at 7:00 tonight” and the conversation model, on behalf of the gaming device, might send an autogenerated natural language message to remind the player at 6:00 pm: “Just a reminder that I'm saving a seat for you tonight at 7, can't wait to see you!”

In one embodiment, the player is able to send or receive unlock codes that cause the command engine to unlock content on a selected gaming device. For example, the player texts “Bonus Mania!” to the conversation model on behalf of the gaming device and that causes the command engine to unlock a new bonus for the player the next time they visit the gaming device.

It is possible a casino emails or sends unlock codes to the player or the conversation model, on behalf of the gaming device, based on player activity or chat activity. In an example of the latter, the conversation model likes sports cars. When the player texts the conversation model on behalf of the gaming device about a certain car, the conversation model is “happy” and gives the player an unlock code for the gaming device or a game theme on the gaming device.

In an embodiment, the conversation model, on behalf of a gaming device, might also text random (e.g., in response to output by the PRNG/RNG 160) or lucky statements such as “I'm feeling lucky today” or “Something is about to happen”. The player might try to figure out the meaning. In one embodiment, the gaming device has a special mode, bonus or award that can be unlocked and the player attempts to figure it out. For example, the 25-cent denomination has a large hidden prize. The gaming device texts the player “I have a large prize ready for a lucky player”.

In an embodiment, luck or superstition might include pictures or emojis. When the player texts certain emojis to the conversation model, on behalf of the gaming device, the command engine may cause the gaming device to change its display state. For example, when the player texts a four-leaf clover to the conversation model, on behalf of the gaming device, the conversation model generates a message to the command engine to cause the reel strips of the gaming machine to change to different symbols. This may or may not change the pay model of the game. Some changes to gaming device behavior may only occur if the player sends the text when the gaming device is within a certain state. For example, if the gaming device is within a Free Spin bonus and the player sends a text with a “happy” emoji, then the color of the reel strips may change in some manner.

In another embodiment, the player can send a text message to the conversation model, on behalf of a gaming device, to change a gaming device behavior in some manner. For example, a traditional slot game is very loud when players hit jackpots to make other players at the casino aware of the win. Unfortunately, some players may view this as a negative experience because they may feel uncomfortable with the attention such a celebration draws, and they may be fearful that they can get attacked in the parking lot or on their way home. A player could text a natural language message to the conversation model, on behalf of the gaming device, asking the gaming device to “be quiet” while the player plays a game. Alternatively, the player could send a natural language message to the conversation model on behalf of the gaming device directing the gaming device to change its volume level. The conversation model would in response send a message to the command engine to cause the volume level to change. In another embodiment, the change could just be associated with the current game cycle rather than the player session (as the gaming device may not be aware of the player's session as the slot machine interface board (SMIB) or service window usually does not tell the host gaming device about the existence of a player session).

In another embodiment, the Bluetooth low energy (BLE) energy and application geolocation data of the communication device 144 can cause the conversation model to send an autogenerated natural language message to aid the player by either reminding the player of his or her location or directing the player to another gaming device with a desired attribute through a peer conversation model (e.g., chatbot) collaboration. For example, while the player is chatting, a first conversation model may indicate that another player is playing a first gaming device desired by the player. The first conversation model may either show a map on the texting application on the communication device 144 or send an autogenerated natural language message comprising a graphic image and/or providing instructions for the player to navigate to the other (second) gaming device or cause the conversations with first and second conversation models on behalf of the first and second gaming devices respectively to be merged together so that autogenerated natural language messages of both the first and second conversation models are being sent to the communication device 144. The second conversation model may introduce itself to the player through an autogenerated natural language message: “I am sorry someone is currently playing your [first conversation model of gaming device name], he or she is a good friend of mine. Would you like to come over to me awhile you are waiting?” This handoff can relay and archive information about each interaction and create a dynamic of two or more independent conversation models communicating with the player through group messaging. To direct the player, the application may use precise locating or augmented reality (AR) technology to guide the player to the second gaming device.

In another embodiment, when a player gets a large jackpot or another award occurs, the conversation model can attempt to make the experience more enjoyable and engaging, while also potentially giving the casino an opportunity to gather photos that can be utilized to improve casino marketing. In one embodiment, when a player gets a jackpot, the gaming device could not delay processing the jackpot until the player acknowledges the “congratulations” autogenerated text sent to them by the conversation model on behalf of the gaming device. For example, the player may be required to “like” the text in order for the jackpot to be sent to a resident system. In another embodiment, the conversation model chatbot could encourage a player to take a selfie of themselves with the winning gaming device and send it to the conversation model when they get a jackpot hit. This may give the conversation model the opportunity to “like” the photo, but it also gives the gaming server the opportunity to collect selfies associated with a jackpot and potentially share them in marketing materials, such as on social media, on billboards, or in other marketing or advertising materials.

In any of the above examples, the player can text or chose to stop receiving texts or communication (“STOP”).

In one embodiment, the gaming device stops communicating with the player after a certain amount of time of the player not responding or the player failing to visit or interact with the EGM in person.

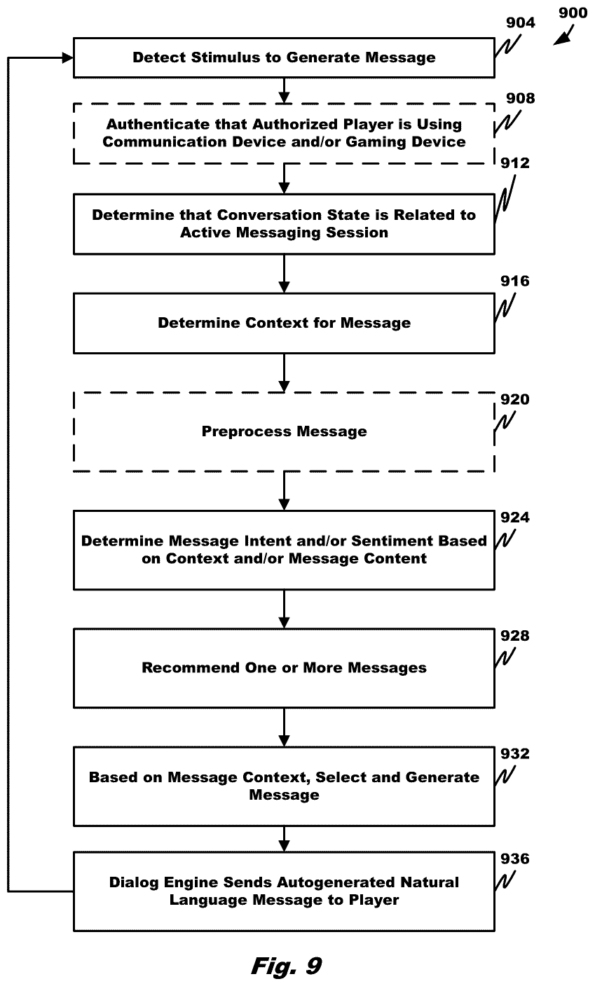

FIG. 9 illustrates an example of a process flow 900 that supports aspects of the present disclosure associated with the conversation model interacting with players via communication devices 144 and/or gaming devices 108. The process flow 900 supports aspects of the present disclosure associated with autogenerating appropriate and/or valid natural language messages. In some examples, process flow 900 may implement aspects of gaming system 100. Further, process flow 900 may be implemented by a gaming system 100 or components included therein as described with reference to FIGS. 1 through 4.

In the following description of the process flow 900, the operations may be performed in a different order than the order shown, or the operations may be performed in different orders or at different times. Certain operations may also be left out of the process flow 900, or other operations may be added to the process flow 900. It is to be understood that any device (e.g., a gaming device 108, a gaming server 116, a communication device 144, components of the system 100, etc.) may perform the operations shown.

Referring now to FIG. 9, a method of using data model(s) to autogenerate natural language messages to players or potential players of a gaming system 100 will be described in accordance with embodiments of the present disclosure. The method can be employed to initiate a conversation with a player or respond to a player message during an existing conversation.

The method begins when the gaming server 116 detects a stimulus to generate a message (step 904).

The stimulus can take many forms.

The stimulus can be the gaming server 116 receiving an incoming natural language message from the player via the dialog engine 146.

The stimulus can be the player entering his or her mobile phone number or other social media communication information via his or her communication device 144 into his or her player profile in the player profile database 148. When the player interacts with a gaming device, he or she logs into the player's account with a player tracking card, mobile application, or username/password. Association with the player can be through another unique identification method, e.g., name, password, code word, address, unique app ID, etc. The information associating the user with a gaming or messaging session could be adjusted and preserved by the operator or frequency of contact. Tiers of player tracking levels, play amounts, or activity can also be applied to shorten or lengthen memory retention of messages in the database 155 for the user and the associated friends and/or family.

The stimulus can be the player inputting his or her mobile phone number or social media contact information at the gaming device 108.

The stimulus can be the player providing permission for the gaming server 116 to access the player's contact list and initiate a conversation with friends and/or family potentially offering to the player for his permission or to contacted friends and/or family members extra bonusing, specialty games, scavenger hunts, or other games to add incentive to participate. A third party application programming interface could be added to link other services at the location, e.g., room readiness status, valet aware of cashout to request vehicle pickup, etc.

The stimulus can be the player initiating a game or gaming session on a gaming device. The event causes the gaming system 116 to ask the player if he or she wants to communicate with the gaming device. In one embodiment, this is shown on the gaming device's user interface (e.g., display) such as by an autogenerated natural language message: “Would you like to talk to this machine via texts?”. In one embodiment, this message is transmitted as a text (“Hi! This is “Luck Larry”. Want to chat with me?””) to the player's communication device 144. In another embodiment, this message is sent as a prompt to the service window or SMIB of the gaming device.

As will be appreciated, other stimuli may be used depending on the application, including the stimuli disclosed above, including expiration of a threshold time interval after a selected player activity (e.g., receipt of a natural language message from a player, ending of a gaming session by the player, a last interaction of the player with the gaming system, etc.), occurrence or non-occurrence of a selected game event, generation of a random variable by the PRNG/RNG 160, a match of a player behavior pattern with a current context (e.g., the system determines that the player usually visits the casino around a current time (such as always during that time of year, or around a particular holiday, or for a particular recurring event, such as New Years, etc.), and the like.

The method continues by optionally authenticating that the authorized player is using the communication device 144 or gaming device 108 (step 908). This can be done by any suitable authentication techniques, such as single use passwords or passcodes, digital certificate, image recognition by gaming system camera still or video images, and other knowledge-based, physiological biometrics-based, behavioral biometrics-based, and two/multi-factor authentication techniques.

The method continues by determining that the conversation state is related to an active messaging session (step 912). When the conversation state is not related to an active messaging session, the conversation model instantiates a new conversation and updates the conversation state accordingly. When the conversation state is related to an active messaging session, the conversation model accesses the prior messages in the player message database 155 related to the existing conversation. This can be determined based on prior occurrence of the endpoint address pair within a predetermined period of time, whether a prior session and the current message relates to a common topic classification, and the like.

The method continues by determining, from gameplay data 400, player information 404, and/or gaming system behavior model 142 output, one or more context categories or events occurring within a predetermined time period of a sent or receipt timestamp of a message or a current time, depending on the implementation (step 916).

When a player message is being responded to, the method continues by the conversation model preprocessing the message (optional step 920).

The method continues by the conversation model, using the context and/or previously received player message(s) to determine a message intent and/or sentiment classification for a prior player message to be responded to and/or for a natural language message to be autogenerated (step 924).

The method continues by the recommendation engine recommending, based on NLP engine 420 input, one or more natural language messages to be autogenerated (step 928). Each proposed message has a corresponding topic classification and/or sentiment classification confidence score based on the context and previously player and autogenerated natural language messages in an existing conversation.

The method continues by the response generator 432 selecting a message, from among the plurality of recommended messages, for auto-generation and generates the natural language message equivalent using the wording, syntax, and grammar consistent with the sentiment classification score (step 932).

The method continues by the dialog engine receiving the autogenerated natural language message and transmitting the message to the player (step 936).

The gaming server returns to step 904 to await occurrence of a next stimulus.

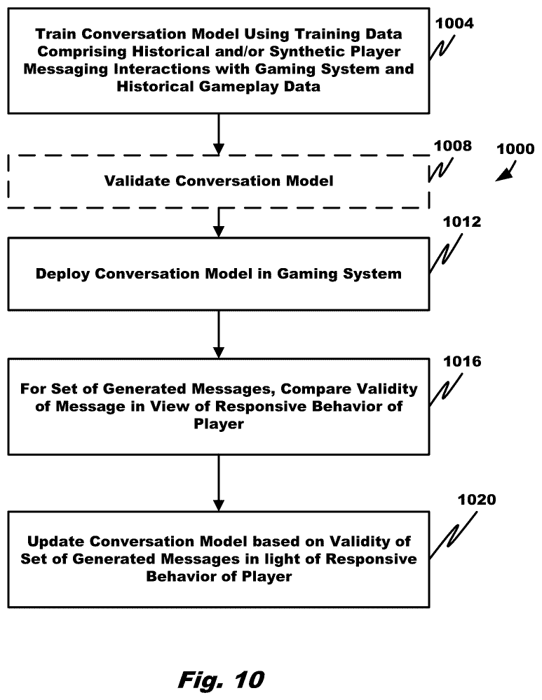

FIG. 10 illustrates an example of a process flow 1000 that supports aspects of the present disclosure associated with generating, training, and applying self-evolving AI-based conversation models described herein. The process flow 1000 supports aspects of the present disclosure associated with a conversation model applied to a gameplay session. In some examples, process flow 1000 may implement aspects of gaming system 100. Further, process flow 1000 may be implemented by a gaming system 100 or components included therein as described with reference to FIGS. 1 through 4.

In the following description of the process flow 1000, the operations may be performed in a different order than the order shown, or the operations may be performed in different orders or at different times. Certain operations may also be left out of the process flow 1000, or other operations may be added to the process flow 1000. It is to be understood that any device (e.g., a gaming device 108, a gaming server 116, a communication device 144, components of the system 100, etc.) may perform the operations shown.

Referring now to FIG. 10, a method of training and updating conversation data model(s) will be described in accordance with embodiments of the present disclosure. The method begins by training a selected conversation model with training data 143 comprising historical or synthetic messaging interactions with the gaming system and historical gameplay data (step 1004).

The autogenerated messages output by the conversation model based on the training data 143 is optionally validated over successive iterations until the message output is substantially optimized for the training data (step 1008) If user validation is desired as part of training the data model(s), then the method may include requesting validation inputs from an administrative/training user.

The conversation model is then deployed in the gaming system (step 1012).

Besides historical data, real-time message interaction and play data can be collected from all potentially participating gaming devices and communication devices across the gaming system (e.g., casino floor) and fed into the same or a connected database. The gaming server 116 may utilize the learning/training module to build the conversation data models 142. In some embodiments, the data models 142 may be trained on hundreds or thousands of player message interaction and gameplay data sets describing events occurring at a gaming device 108 and/or communication device 144 when a player 112 interacts with the gaming device 108 and/or communication device 144. The training of the data models may or may not include user validation (e.g., human feedback).

By way of illustration, for a set of generated messages, the learning/training module can compare the validity of a message in view of a responsive behavior of the player (step 1016). In an implementation, the conversation model outputs a natural language message and corresponding target player behavior pair. When the player responds in accordance with the target player behavior, the corresponding message is presumed to be valid. Conversely, when the player fails to respond in accordance with the target player behavior, the corresponding message is not presumed to be valid.

The method can continue by updating the conversation model based on the validity of a set of generated messages in light of the responsive behavior of the player (step 1020).

A similar process may be employed for creating and training the gaming system behavior model 142. By way of example, the machine learning network can start with creating and training baseline models with historical game play data 400 and 404. This could be either granular or summarized gameplay data showing each gaming device's summarized performance data for a period of time. While granular gameplay data, based on spin level (e.g., every single game action tracked per EGM) can provide far more details and insights, such detailed gameplay data can also require significantly more CPU power to be processed. The granular gameplay data can be used to train the individual player behavior models while summarized gameplay data can be used to train the representative player behavior and gaming system behavior models. Which training data is employed can vary by gaming system configuration (e.g., available processing resources) and requirements.

Initially, gaming system behavior models are trained using historical gameplay data (summarized and/or granular) to have artificial “average behavior models” to simulate a set of gameplay operations. These models could be fed continuously with newly generated gameplay data, e.g., in real-time, once per month etc. and thus, be kept up to date and realistic to the most recent play behavior.

From a database where all data from all machines on the floor are collected, these features are extracted which can be important to creating valid historical gaming system models, such as “number of players in the venue”, “time of the day”, “crowded casino areas” and many more from the plurality of EGMs among the casino floor. Calculations may be required to better understand correlations and impacts from one feature to another, enabling more detailed insights and leading to even more expressive new features.

In some embodiments, the performance of the conversation and gaming system behavior models may be monitored based on the data received from the message and gameplay data streams as compared to output of the models to determine if the actual data is deviating from outputs produced by the respective model. Some deviation may be tolerated, but if the deviation exceeds a predetermined deviation threshold, then the method may continue with the gaming server 116 determining to update or replace the output-producing data model from which the actual data has deviated by more than the predetermined deviation threshold.

For example, the gaming server 116 (e.g., machine learning engine or learning/training module) may determine a probability score for modifying a model (such as a conversation model or gaming system behavior model) based on a correlation between actual behavior and behavior predicted by the model. In some examples, the machine learning engine may output a relatively low probability score for modifying the model for cases in which the machine learning engine identifies relatively high correlation (e.g., above a threshold) between the actual behaviors. In some other examples, the machine learning engine may output a relatively high probability score for modifying the model for cases in which the machine learning engine identifies a relatively low correlation (e.g., below a threshold) between the behaviors.

In some aspects, training of the initial baseline model may be performed in association with training specifications that are based on the size of data (e.g., training data) available. In an example, after training of the initial baseline model, the initial baseline model may be applied to generate a prediction (e.g., gameplay decision, gameplay outcome, etc.) during a gameplay session. Upfront, the initial baseline model predicts what will happen in an event X. Once the event X occurs, the gaming server 116 may compare the actual outcome associated with the event X to the predicted outcome. The gaming server 116 may continuously compare actual outcomes to predicted outcomes, which may support continuously measuring the accuracy of the model.

A (data) model may be updated by changing one or more coefficients or tunable parameters connecting one or more nodes in a neural network. Alternatively or additionally, a (data) model may be updated by adding or subtracting one or more nodes or node levels from the model to more closely align outputs of the (data) model to actual data observed on the message and gameplay data streams. A (data) model may be replaced by being deleted from memory and then having a different/new (data) model stored as a replacement therefor.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central gaming server, central gaming controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A system comprising:
a communication interface;
a processor coupled with the communication interface; and
a computer-readable storage medium coupled with the processor, the computer-readable storage medium storing a conversation model thereon that enables the processor to:
receive a natural language communication from a communication device of a player in a communication session with a gaming system;
analyze the received natural language communication to determine a topic classification and a corresponding topic confidence score, the corresponding topic confidence score being based, at least in part, on information associated with a state of the gaming system;
select, based on the corresponding topic confidence score, a natural language response; and
transmit the selected natural language response to the player's communication device.

2. The system of claim 1, wherein, during the communication session, the player is engaged in a gaming session with a gaming device of the gaming system, wherein the state of the gaming system comprises one or more of the following characteristics of the gaming session: game outcome, game theme, speed of play, cash in amount, wager behavior, wagering speed, cash out amount, play session length, additional in-session cash in amounts, and idle time, wherein the received natural language communication and selected natural language response each comprise a text communication, and wherein the conversation model comprises a natural language processing model.

3. The system of claim 1, wherein the conversation model enables the processor to receive gameplay data of a plurality of gaming sessions of a plurality of players on a plurality of gaming devices of the gaming system and configuration data associated with each of the plurality of gaming devices, wherein each of a plurality of communication sessions of multiple of the plurality of players share a common host communication address associated with the gaming system, wherein the state of the gaming system is based on the gameplay data and configuration data, wherein a plurality of communication sessions are concurrently active with a plurality of communication devices of the plurality of players, and wherein a different conversation model is interacting with each communication device in each of the communication sessions.

4. The system of claim 1, wherein the conversation model enables the processor to select the conversation model based on a loyalty account status, a set of player preferences, a player social media data, and/or gameplay of the player, and wherein the conversation model enables the processor to transmit an initial natural language communication to the communication device of the player during the communication session, wherein the conversation model enables the processor to transmit the natural language communication in response to a passage of time, a gaming event in a gaming session of the player, an event of the gaming system, and/or a level of player engagement with the gaming system.

5. The system of claim 1, wherein the natural language communication and the natural language response relate to one or more of a location associated with the gaming system, an identifier associated with the gaming system, information associated with a state of the gaming system, an activity level of the gaming system, and an event associated with the gaming system, wherein, in response to the player interacting with a gaming device of the gaming system, the processor transfers an endpoint communication address of the player's communication device to a communication address of the gaming device to enable the gaming device to send and receive player communications during the communication session.

6. The system of claim 1, wherein the processor identifies an actual behavior of the player in response to the selected natural language response and updates the conversation model based on a validity of the selected natural language response in view of the actual behavior of the player, wherein the natural language response is associated with a target player behavior, wherein the processor update of the conversation model is based on a difference between the actual behavior and the target player behavior, and wherein the target and actual player behaviors relate to one or more of content of a subsequent communication received from the player and an action of the player.

7. The system of claim 6, wherein the conversation model is a machine learning model, wherein training data for the machine learning model comprises gameplay data associated with a gaming device of the gaming system and historic player behavior data associated with one or more players comprising the player, wherein the conversation model enables the processor to determine a physical location of the player relative to the gaming system, and wherein target behavior is selected based on the physical location and information associated with a state of a gaming device in the gaming system.

8. A method, comprising:
assigning a conversation model to interact with a player in a communication session with a communication device of the player, the conversation model being associated with a gaming system;
receiving a natural language communication from a communication device of the player in the communication session;
based at least in part on information associated with a state of the gaming system and natural language processing of the received natural language communication, selecting, by the conversation model, a natural language response to the received natural language communication;
transmitting the selected natural language response to the communication device of the player;
identifying an actual behavior of the player in response to the selected natural language response; and
updating the assigned conversation model based on a difference between the actual behavior and a target behavior of the player associated with the selected natural language response.

9. The method of claim 8, wherein the selecting is based in part on a conversation state of the communication session, wherein, during the communication session, the player is engaged in a gaming session with a gaming device of the gaming system, wherein the state of the gaming system comprises one or more of the following characteristics of the gaming session: game outcome, game theme, speed of play, cash in amount, wager behavior, wagering speed, cash out amount, play session length, additional in-session cash in amounts, and idle time, wherein the natural language communication and responsive communication each comprise a text communication, wherein the conversation model comprises a natural language processing model, and wherein the target and actual player behaviors relate to one or more of content of a subsequent communication received from the player and action of the player.

10. The method of claim 8, wherein each of a plurality of concurrent communication sessions with a plurality of players share a common host communication address associated with the gaming system, wherein a plurality of communication sessions are concurrently active with a plurality of communication devices of a plurality of players, and further comprising:
assigning a different conversation model to each communication session to interact with a corresponding communication device; and
receiving gameplay data of a plurality of gaming sessions of the plurality of players and configuration data associated with each of a plurality of gaming devices interacting with the plurality of players, wherein the state of the gaming system is based on the gameplay data and configuration data.

11. The method of claim 8, wherein the assigning comprises selecting the conversation model based on a loyalty account status, set of player preferences, player social media data, and/or gameplay of the player, and further comprising:
transmitting a natural language communication to the communication device of the player in response to a passage of time, a gaming event in a gaming session of the player, an event of the gaming system, and/or a level of player engagement with the gaming system, wherein the actual behavior of the player in response to the selected natural language response is identified based on a content of a further communication received from the player in response to the selected natural language response.

12. The method of claim 8, wherein the received natural language communication and the natural language response relate to one or more of a location associated with the gaming system, an identifier associated with the gaming system, information associated with a state of the gaming system, an activity level of the gaming system, and an event associated with the gaming system and further comprising:
in response to the player interacting with a gaming device of the gaming system, launching a new messaging session between the communication device of the player and the gaming device and transferring a context of the messaging session to the new messaging session.

13. The method of claim 8, further comprising:
determining a physical location of the player relative to the gaming system, wherein target player behavior is selected based on the physical location and information associated with a state of a gaming device in the gaming system; and
authenticating that the communication device is associated with the player before transmitting the natural language communication.

14. The method of claim 8, wherein the assigned conversation model is a machine learning model, wherein training data for the machine learning model comprises gameplay data associated with a gaming device of the gaming system and historic player behavior data associated with one or more players comprising the player.

15. A gaming system comprising:
a communication interface;
a processor coupled with the communication interface; and
a computer-readable storage medium coupled with the processor, the computer-readable storage medium storing data thereon that enables the processor to:
receive a natural language communication from a communication device of a player of a gaming device during a gaming session;
extract, by natural language processing, one or more keywords from the natural language communication to identify an intent of the natural language communication;
receive information associated with a state of the gaming system;
determine a sentiment classification and a corresponding sentiment confidence score for the received natural language communication, the corresponding sentiment confidence score being based, at least in part, on the received gaming system state information;
select, based on the corresponding sentiment confidence score, a natural language response; and
transmit the selected natural language response to a communication device of the player.

16. The system of claim 15, wherein the gameplay data comprises one or more of the following characteristics of the gaming session: game outcome, game theme, speed of play, cash in amount, wager behavior, wagering speed, cash out amount, play session length, additional in-session cash in amounts, and idle time, wherein the data comprises a conversation model, wherein the processor identifies an actual behavior of the player in response to the selected natural language response and updates the conversation model based on a validity of the selected natural language response in view of the actual behavior of the player, wherein the natural language response is associated with a target player behavior, wherein the processor updates of the conversation model is based on a difference between the actual behavior and the target player behavior, and wherein the target and actual player behaviors relate to one or more of content of a subsequent communication received from the player and an action of the player.

17. The system of claim 15, wherein the processor receives gameplay data of a plurality of gaming sessions of a plurality of players on a plurality of gaming devices of the gaming system and configuration data associated with each of the plurality of gaming devices, wherein each of the players is involved in a plurality of communication sessions, wherein each of the plurality of communication sessions share a common host communication address associated with the gaming system, wherein the processor selects the natural language response based on information associated with a state of the gaming system, wherein the state of the gaming system is based on the gameplay data and configuration data, wherein a plurality of communication sessions are concurrently active with a plurality of communication devices of the plurality of players, and wherein a different conversation model is interacting with each communication device in each communication session.

18. The system of claim 15, wherein the natural language communication and the selected natural language response relate to one or more of a location associated with the gaming system, an identifier associated with the gaming system, information associated with a state of the gaming system, an activity level of the gaming system, and an event associated with the gaming system, wherein, in response to the player interacting with a gaming device of the gaming system, the processor replaces an endpoint communication address of the communication device of the player with a communication address of the gaming device to enable the gaming device to send and receive player communications during the gaming session.

19. The system of claim 15, wherein the data comprises a conversation model, wherein the natural language communication is received from a common device of the player, wherein the processor determines a physical location of the player relative to the gaming system, wherein the conversation model is updated based on a comparison between a target behavior associated with the selected natural language response and an actual behavior of the player in response to the natural language response, wherein the target behavior is selected based on the physical location and information associated with a state of the gaming device in the gaming system, and wherein the processor authenticates that the communication device is associated with the player before transmitting the natural language communication.

20. The system of claim 15, wherein the data comprises a conversation model, wherein the conversation model is a machine learning model, wherein training data for the machine learning model comprises gameplay data associated with a gaming device of the gaming system and historic player behavior data associated with one or more players comprising the player, wherein the processor selects the conversation model from a plurality of conversation models based on a loyalty account status, a set of player preferences, a player social media data, and/or gameplay of the player, and wherein the actual behavior of the player in response to the selected natural language response is identified based on further gameplay data associated with the gaming session.
